(19) United States
(12) Patent Application Publication
(10) Pub. No.: US 2003/0200262 A1
(43) Pub. Date: Oct. 23, 2003

(54) Network service system

(75) Inventor: Hajime Enomoto, Funabashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/396,351

(22) Filed: Mar. 26, 2003

(30) Foreign Application Priority Data
Apr. 17, 2002 (JP) 2002-115287

(51) Int. Cl. G06F 15/16

(52) U.S. Cl. 709/205

(57) ABSTRACT

A network service system according to the present invention is configured by one or more, generally, a plurality of intention realization data processing devices, an overall external environment data managing unit, and a network. Each intention realization data processing device comprises a common platform as an interface with a party, and an object network for realizing the intention of the party. The overall external environment data managing unit can be referenced in a parallel manner via each intention realization data processing device when each party requires the data, and centrally manages common data for providing/receiving a service.

### BACKGROUND OF THE INVENTION

1. Field of the Invention

The present invention relates to a network service system for providing/receiving a service among a plurality of parties via a network, and more particularly, to a network service system using an intention realization data processing device that comprises a common platform as an interface capability with a party, and an object network for realizing the intention of a party.

2. Description of the Related Art

With the extensive use of an overall network system such as the Internet, a network service system that provides/receives a service among a plurality of parties by using a network has been implemented. For example, a system where media data is provided with a bidirectional capability, and an interaction is made among a plurality of parties via a network has been implemented.

In such a system, it is important that a responsible party exists in an entire media system, or a particular medium as part of the media system in correspondence with the intention of a party as a client, and an interaction which lets the particular medium, for example, make a movement suitable for an environment in correspondence with the intentions of the client and of the responsible party.

Additionally, if a partial scene as a cut exists in a media, and if an interaction that edits the cut and virtually makes a dynamic simulation for a system is made, a system having a bidirectional capability must be constructed to perform an editing operation for integrating partial media such as a picture, music, audio media, etc.

As described above, as a system executing, for example, a request issued from a client as a user, namely, a service requested as the intention of the client, a WELL (Window-based Elaboration Language) system using a functional language abbreviated to a WELL exists. With the WELL system, a service is not limited to a particular field, and a service corresponding to a variety of fields can be executed by using an object network designed as a field description language corresponding to a service field.

Here, the object network is implemented by putting data and various types of operations for the data into models. The WELL system comprises a common platform which serves as an interface having various types of windows on which a user gives an instruction or data in correspondence with the object network, or an execution result of the system, etc. are displayed. The object network, the common platform, and the WELL system are disclosed by the following documents as the applications previously filed by the present applicant.

Document 1) Japanese Patent Publication H5(1993)-233690 “Language Processing System Using an Object Network)

Document 2) Japanese Patent Publication No. H7(1995)-295929 “Interactive Information Processing Device Using a Common Platform Capability”

Document 3) Japanese Patent Publication No. H9(1997)-297684 “Information Processing Device Using an Object Network”

Additionally, by using the above described WELL system, the present applicant also filed a previous application of an intention realization data processing device, which is intended to realize any of an independent intention that can be independently realized by one client, a common intention that can be realized in such a way that one of a plurality of clients cooperatively operates with intentions of the other clients, and a contradictory intention that can be realized in such a way that one of a plurality of clients operates contradictory to intentions of the other clients. Details of this system will be described later.

The above described system comprises a bidirectional capability as its system structure, which means that a plurality of parties exist in the overall environment of the system. These parties, for example, include a client that issues a request to execute a service, a server that receives this request, and, generally, a plurality of responsible parties that execute a partial role capability for providing a service. The plurality of responsible parties perform a cooperative operation with a common intention to realize the request as the intention of the client.

In such a case, for example, the plurality of parties comprise the above described intention realization data processing device respectively, and perform an external operation for the overall environment of the system via the device. As a result, the operations of the parties are reflected on data of the overall environment of the system, namely, overall external environment data. However, to continue the intention realization process by each of the parties, the party must reference the overall external environment data depending on need, and perform an operation for the overall environment thereafter so as to make consistency with the contents of the overall external environment data.

Accordingly, to implement the above described system, it is essential that common data for providing/receiving a service, namely, overall external environment data is centrally managed, and a plurality of parties are allowed to reference the data in a parallel manner when they require the data. Conventionally, for instance, part of such overall external environment data is stored in any of memories of a plurality of intention realization data processing devices. Therefore, there is a problem that parties other than a party that uses that data processing device are difficult to access the partial data.

### SUMMARY OF THE INVENTION

An object of the present invention is to provide a network service system that can centrally manage common data for providing/receiving a service among a plurality of parties, and enables each of the plurality of parties to reference the data in a parallel manner at the time point when each of the parties requires the data, in view of the above described problems.

A network service system according to the present invention is a network service system with which a service is provided/received among a plurality of parties via a network. This system is configured by one or more, generally, a plurality of intention realization data processing devices, an overall external environment data managing unit, and a network.

The intention realization data processing device is an object-oriented data processing device with which each party implements the provision/reception of a service. This device comprises a common platform as an interface capability with a party, and an object network for realizing the intention of the party.

The overall external environment data managing unit centrally manages common data that can be referenced by respective parties in a parallel manner via their own intention realization data processing devices when they require the data, and is intended to provide/receive a service.

### BRIEF DESCRIPTION OF THE DRAWINGS

FIG. 1 is a block diagram showing the principle of the configuration of the present invention;

FIG. 2 is a block diagram showing the fundamental configuration of an information processing device using an object network;

FIG. 3A explains a general object network (No. 1);

FIG. 3B explains the generic object network (No. 2);

FIG. 3C explains translations for the generic object network to specific object network (No. 3);

FIG. 4A shows a specific example of an object network (No. 1);

FIG. 4B shows a transforms of the data in the specific example of the object network (No. 2);

FIG. 5 is a block diagram showing the details of the configuration of a noun object management mechanism;

FIG. 6 explains the execution management of a specific function corresponding to a verb object;

FIG. 7 is a block diagram showing the fundamental configuration of an information processing device comprising a common platform which serves as an interface with a user;

FIG. 8 explains a WELL system corresponding to a color picture generation/coloring process field;

FIG. 9 is a flowchart showing data processing using an object network (No. 1);

FIG. 10 is a flowchart showing the data processing using the object network (No. 2);

FIG. 11 shows a color picture generation/coloring processing method from a client to a server;

FIG. 12 exemplifies a template;

FIG. 13 exemplifies a template corresponding to a line segment;

FIG. 14 explains a method generating a specific object network from a generic object network;

FIG. 15 is a block diagram showing the configuration of an information processing device having an agent;

FIG. 16 is a block diagram showing the configuration of an information processing device in consideration of the existence of an expert;

FIG. 17 explains the definition of a role capability;

FIG. 18 explains the movements of a process within a WELL system for implementing an interaction capability;

FIG. 19 is a flowchart showing the process of the interaction capability;

FIG. 20 explains the interaction capability between a main role capability and a support role capability;

FIG. 21 explains one-to-multi broadcasting from a main role capability to subordinate role capabilities;

FIG. 22 explains a communication among role capabilities;

FIG. 23 explains a consistency prediction process corresponding to a common intention;

FIG. 24 explains a consistency/inconsistency prediction process corresponding to contradictory intentions;

FIG. 25 explains movement conversion with a strategy and a tactic for a common intention and a contradictory intention;

FIG. 26 is a block diagram showing the outline of the entire structure of an intention realization data processing device;

FIG. 27 explains a process performed with data driving for realizing an intention;

FIG. 28 explains a hierarchical structure of event drivings in a cooperative process with a broadcasting capability;

FIG. 29 explains a cooperative process performed with a partial recognition capability of environment data;

FIG. 30 explains a user process performed for an object network;

FIG. 31 explains the relationship between a party associated with a consistent restriction, and a driving system;

FIG. 32 explains the cell contents of a template of an object;

FIG. 33 shows the contents of a template for dynamically controlling a verb object;

FIG. 34 shows the definition structure of an intention;

FIG. 35 shows the entire configuration of a generic object network for realizing an intention;

FIG. 36 explains a generic object network for a strategy/tactic;

FIG. 37 explains the connection structure of servers to realize an intention;

FIG. 38 explains a communication method among the servers shown in FIG. 37;

FIG. 39 explains a bidirectional interaction capability in a network service system;

FIG. 40 explains a parallel definition process for an intention;

FIG. 41 explains an execution process of the intention of each party;

FIG. 42 explains the flow of an intention execution process performed with event driving;

FIG. 43 explains a process execution with a mutual operation of role capabilities;

FIG. 44 shows the configuration of a role definition network;

FIG. 45 explains a service execution process according to a service category of each server;

FIG. 46 explains the operations of a service system corresponding to a soccer game;

FIG. 47 explains a syntax analysis capability of a service name;

FIG. 48 explains a security ensuring method in a communication service (No. 1);

FIG. 49 explains the security ensuring method in the communication service (No. 2);

FIG. 50 explains a data protection method when a service is executed;

FIG. 51 shows the structure of a service network management system; and

FIG. 52 explains the loading of a program for implementing the present invention into a computer.

### DESCRIPTION OF THE PREFERRED EMBODIMENTS

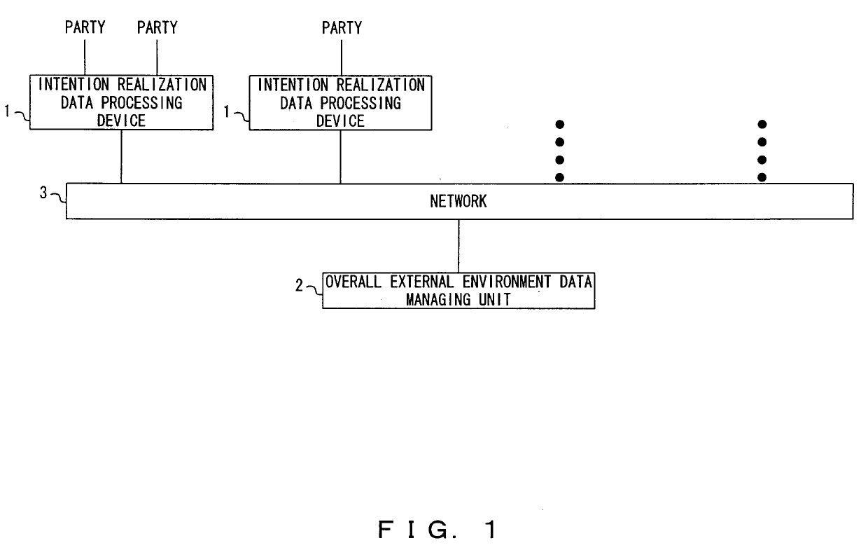

FIG. 1 is a block diagram showing the principle of the configuration of a network service system according to the present invention. This figure is a block diagram showing the principle of the configuration of the network service system where a service is provided/received among a plurality of parties via a network.

In FIG. 1, the system is configured by one or more, generally, a plurality of intention realization data processing devices 1, an overall external environment data managing unit 2, and a network 3. Here, the overall external environment data managing unit 2 is formed to be accessed by each of the plurality of intention realization data processing devices 1 via the network 3. However, the overall external environment data managing unit 2 can be directly accessed by each of the plurality of intention realization data processing devices 1 not via the network 3, as a matter of course.

In FIG. 1, each of the intention realization data processing devices 1 is an object-oriented data processing device with which each party realizes an intention to provide/receive a service. This device comprises a common platform as an interface capability with a party, and an object network for realizing the intention of the party.

In FIG. 1, the number of parties that use each of the intention realization data processing devices 1 may be one or plural.

The overall external environment data managing unit 2 centrally manages common data that can be referenced by each of parties in a parallel manner via each intention realization data processing device 1 when requiring the data, and is intended to provide/receive a service.

In a preferred embodiment of the present invention, the intention realization data processing device 1 may further comprise an intention target area defining unit defining a service target area as a target area of an intention, and the overall external environment data managing unit 2 may centrally manage the data of the service target area.

Additionally, in the preferred embodiment of the present invention, the intention realization data processing device 1 may further comprise a consistency determining unit determining a consistent restriction condition corresponding to the goal of a service provided/received among the plurality of parties.

In this case, the consistency determining unit may protect the privacy of a communication by checking a consistent restriction condition for the communication made between the overall external environment data managing unit 2 and the intention realization data processing device 1, and between intention realization data processing devices.

Additionally, the above described object-oriented object has a hierarchical structure configured by: a data model whose attribute structure is decided as a template; an object model which is positioned higher than the data model, and comprises the above described object network having a graph structure where the name of a noun object is a node, and the name of a verb object is a branch; a role model which is positioned higher than the object model, and represents the contents of a process to be executed in an environment as an assembly of object models; and a process model which is positioned highest, and defines a dynamic process cooperatively executed by a plurality of role models as one process. Furthermore, the consistency determining unit may perform a control for realizing a service intended by a party according to the determination of a consistent restriction condition item added to a template.

Furthermore, in the preferred embodiment of the present invention, the overall external environment data managing unit 2 may accumulate a result of an intention operation, which is performed based on external environment data in correspondence with the intentions of a plurality of parties via intention realization data processing devices 1, as a characteristic parameter for each of the plurality of parties.

In this case, the intention realization data processing device 1 may further comprise an intention execution supporting unit extracting the characteristic parameter accumulated in the overall external environment data managing unit 2 so as to evaluate and adapt the intention operation performed in correspondence with the intentions of the plurality of parties.

Additionally, in this case, the plurality of parties correspond to parties of a team composed of a manager and team members, and each of the parties extracts the characteristic parameter accumulated in the overall external environment data managing unit 2 by using the intention execution supporting unit, so that the intention as the team can be also realized.

Also in this case, the intention realization data processing device 1 may further comprise a system adapting unit which makes system adaptation for realizing the intention of a party in correspondence with a service category as a service menu corresponding to each of the plurality of parties associated with the manager side.

As described above, according to the present invention, common data for providing/receiving a service is centrally managed in a network service system where the service is provided/received among a plurality of parties via a network, and each of the plurality of parties can reference the data in a parallel manner when requiring the data.

The preferred embodiment of the present invention is described in detail below.

According to the present invention, nodes which respectively correspond to a plurality of parties using a network service system comprise an intention realization data processing device, for example, respectively, the intention realization data processing devices of the respective nodes operate in parallel, common data for providing/receiving a service is stored, for example, in a shared memory within the network, and each of the intention realization data processing devices references the contents of the memory in a parallel manner when requiring the data, and executes a process for providing/receiving the service. Prior to an explanation of such a process, an object network, a common platform, and the intention realization data processing device realizing the intention of a system party such as a client, etc., which are preconditions of the above described process, are explained. Fundamental configuration, etc. are disclosed for such an intention realization data processing device by the following applications previously filed by the present applicant.

Document 4) Japanese Patent Publication No. H11(1999)-312087 “Intention Realization Information Processing Device”

Document 5) Japanese Patent Application No. 2000-240581 “Information Processing Device”

Document 6) Japanese Patent Application No. 2001-089207 “Security Securing Method in a Service Capability Execution System”

This intention realization data processing device adopts an extensible WELL system (Ext. WELL), which uses an object network as a language processing capability, and a common platform as an interface capability between a client and a server, as key concepts.

As described above, such a WELL system is not limited to a particular field, and can execute a service capability in a variety of fields. Providing a unified architecture of the network service system that is not limited to a particular field with the use of such a WELL system is an important point of the present invention.

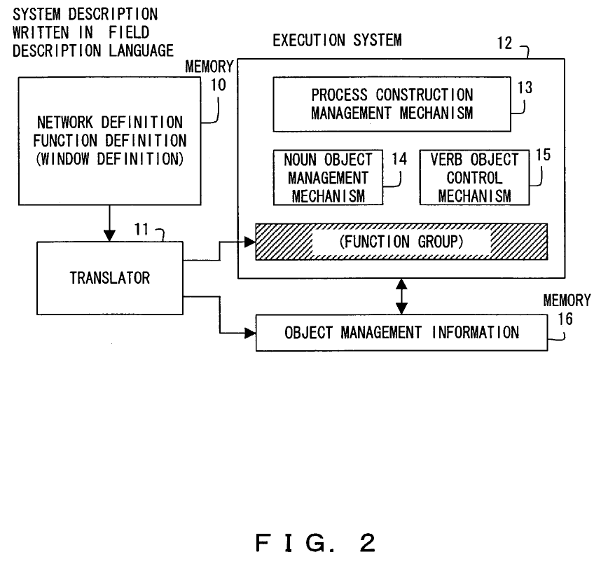

FIG. 2 is a block diagram showing the fundamental configuration of an information processing device using an object network. In this figure, an information processing system comprises: a memory 10 storing a system description written in a field description language; a translator 11 analyzing a syntax upon receipt of an input of the system description, and generating data for an execution system 12; the execution system 12; and a memory 16 storing management information of an object network within the data generated by the translator 11.

The memory 10, which stores the system description written in the field description language, also stores the definition of the object network, the definitions of necessary functions, the definitions of windows, etc. The windows will be described in association with a common platform to be described later.

The execution system 12 includes a process construction management mechanism 13 performing a control for a parallel process execution etc., a noun object management mechanism 14 managing a noun object among objects which configure the object network, and a verb object control mechanism 15 having an execution control capability of a verb object.

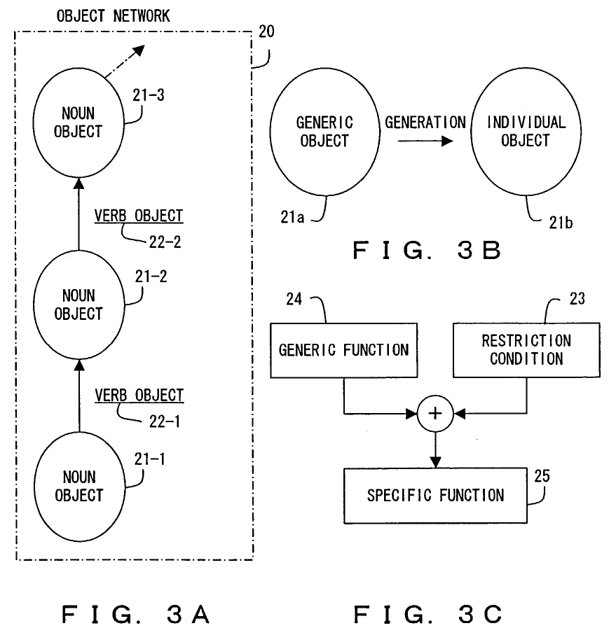

FIGS. 3A to 3C explain a general object network. The object network is intended to manage data of an information processing device, and an operation means for the data as objects. The objects are broadly classified into two types such as a noun object and a verb object. As shown in FIG. 3A, an object network 20 where noun objects and verb objects are respectively represented as nodes and branches is configured. The object network is configured by executing the contents of a function corresponding to a verb object as a branch for a noun object as a node within the object network so that the noun object at the tip of the branch corresponding to the verb object is obtained as a goal target.

As shown in FIG. 3B, a generic object 21a corresponding to common nouns, and an individual object 21b corresponding to a proper noun exist for the noun object 21, and the individual object 21b is generated from the generic object 21a.

Additionally, as shown in FIG. 3C, two function types such as a generic function 24 and a specific function 25 exist for the verb object. The specific function 25 is a function that can actually perform an execution process for a noun object when obtaining the noun object as a goal target. The specific function 25 is obtained by adding a restriction condition 23 to the generic function 24. Conversion from the generic function 24 to the specific function 25 is controlled by the verb object control mechanism 15.

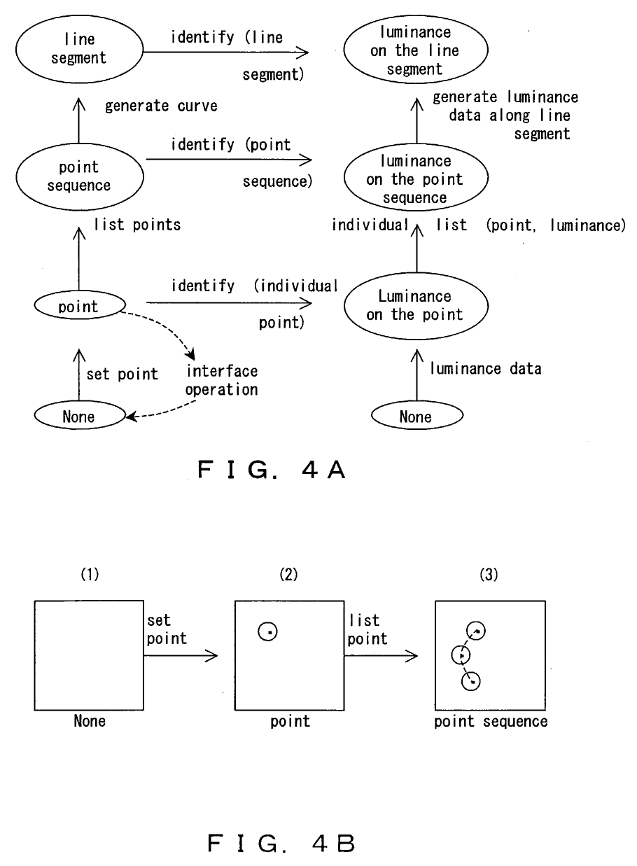

FIGS. 4A and 4B show a specific example of the object network. This network is an object network whose field of a system description, which is stored in the memory 10 of FIG. 2 and written in a field description language, relates to a picture field, and is intended to draw a picture. The left side and the right side of FIG. 4A respectively show an item network, and an attribute network. These two networks configure the object network.

The item network on the left side of FIG. 4A is first described. As shown in FIG. 4B, nothing is displayed in the initial state (1) when a picture is drawn. For example, a user specifies a certain point on a display with a mouse, etc., so that an operation corresponding to a verb object “set point” is performed, and a noun object “point” shown in (2) is obtained. A plurality of points corresponding to this “set point” are drawn, for example, with an interface operation with the user, and an operation corresponding to a verb object “list points” is performed for these points, whereby a noun object “point sequence” shown in (3) is obtained. Furthermore, a verb object “generate curve” is executed for this noun object, so that a noun object “line segment” corresponding to, for example, a line segment is obtained.

The object network on the right side of FIG. 4A is intended to color a picture in correspondence with the item network on the left side, when the picture is drawn. Each noun object in the attribute network is identified by a corresponding noun object in the item network. Also in the attribute network, a noun object “luminance on the point”, which specifies the luminance of each point, is obtained by executing a verb object “luminance data” from the state where nothing is displayed. Additionally, a point list “individual list”, and an object specifying the luminance on the point are executed, whereby a noun object “luminance on the point sequence” is obtained. Furthermore, a verb object “generate luminance data along line segment” is executed, thereby obtaining a noun object “luminance on the line segment”. As a result, a color picture is finally obtained based on this noun object.

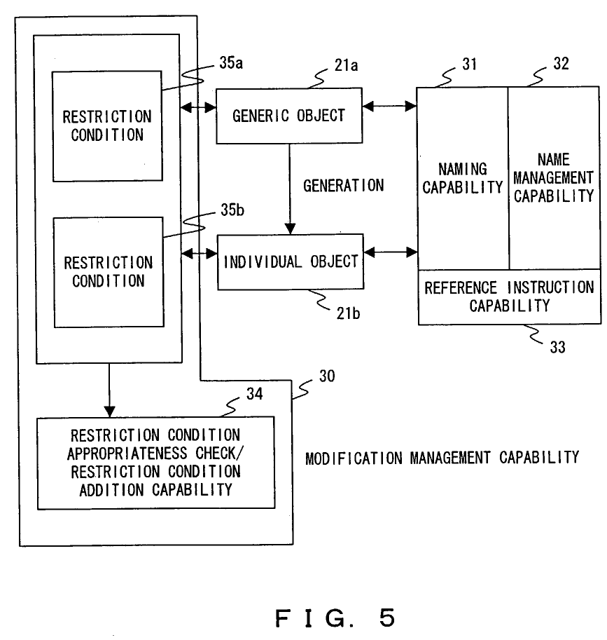

FIG. 5 is a block diagram showing the details of the configuration of the noun object management mechanism 14 shown in FIG. 2. In this figure, the noun object management mechanism is configured by a modification management capability 30, a naming capability 31, a naming management capability 32, and a reference instruction capability 33. The noun object management mechanism is intended to manage the generic object 21a and the individual object 21b.

The modification management capability 30 comprises restriction conditions respectively for the generic object 21a and the individual object 21b, for example, restriction conditions 35a and 35b as adjectives that modify a noun object, and also comprises a restriction condition appropriateness checking/restriction condition addition capability 34 determining the appropriateness of these restriction conditions.

The naming capability 31 allows a user or the system to give a name, for example, to the individual object 21b. The name management capability 32 manages the name. The reference instruction capability 33 allows, for example, a particular individual object 21b to be referenced by distinguishing the particular object from other objects.

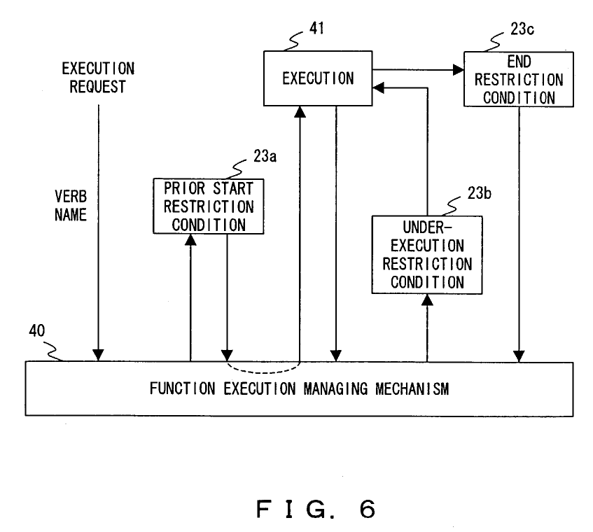

FIG. 6 explains the execution management of a specific function corresponding to a verb object. In this figure, the execution management of a function is made by a function execution management mechanism 40, which is not shown in FIG. 2.

The function execution management mechanism 40 manages execution 41 of a specific function based on conditions such as a prior start restriction condition 23a, an under-execution restriction condition 23b, and an end restriction condition 23c of the execution of a specific function, when the specific function corresponding to a specified verb object is executed. Namely, the function execution management mechanism 40 gets the execution 41 of the specific function made after checking the prior start restriction condition 23a along with other restriction conditions, also checks the under-execution restriction condition 23b during the execution of the function, and further checks the end restriction condition 23c when the execution of the function is terminated, in response to a request to execute the function.

For example, when an arc is drawn, coordinate values of at least three points must be set. If coordinate values of only two points are set, execution of a function for drawing an arc cannot be made. However, by checking the prior start restriction condition 23a, the function execution management mechanism 40 can check such a condition beforehand, and can also automatically activate a function for requesting a user to input the coordinate values of the third point if necessary.

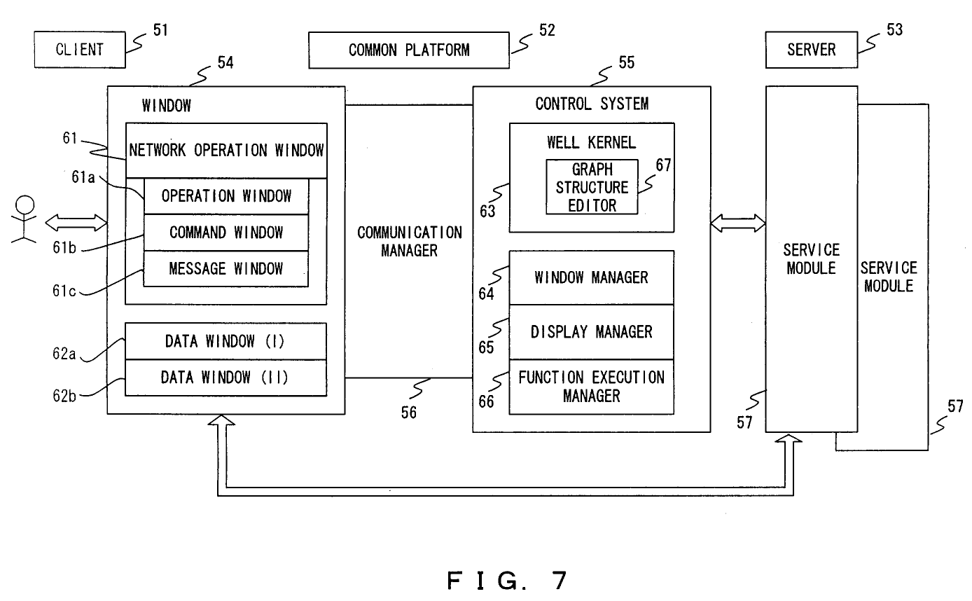

The common platform is described next. FIG. 7 is a block diagram showing the fundamental configuration of an information processing device comprising a common platform 52 as an interface between a client 51, for example, a user and a server 53 for executing a process instructed by the client. In this figure, the common platform 52 comprises a window 54 for inputting/outputting data to/from the client 51, a control system 55, and a communication manager 56 for making consistency of a data display format, etc. between the window 54 and the control system 55. Additionally, the server 53 is configured, generally by a plurality of service modules 57.

The window 54 is configured by a network operation window 61, and a data window 62. An operation window 61a of the network operation window 61 is intended to display a picture or characters, which enables each type of an operation to be instructed, for example, from the client 51 side. The command window 61b is intended to display a picture or characters, which enables each type of a command to be instructed from the client side. A message window 61c is intended to display a message, for example, from the system side to the client. The data window 62 is configured by a data window (I) 62a for displaying a process result, and a data window (II) 62b for displaying restriction data required for a process, and the like.

The communication manager 56 has a duty to convert the representation format of data that is exchanged between the client 51 and the server 53 via the window 54. The conversion of the representation format will be further described later.

The control system 55 is, for example, part of a WELL system to be described later, and is configured by a WELL kernel 63 for controlling a process corresponding to an object network, a window manager 64 for controlling a selection of each window type of the window 54, etc., a display manager 65 for controlling a data display on a window, etc., and a function execution manager 66 for controlling the execution of a function corresponding to a verb object in an object network. Furthermore, the WELL kernel 63 comprises a graph structure editor 67 for processing the graph structure of an object network by recognizing the object network as one type of data.

In FIG. 7, if a process target instruction is issued from the client 51, the server 53 calls an object network which represents its process target area. The graph structure editor 67 stores the object network in the working area of the WELL kernel 63. Based on this storage result, the object network is displayed on the operation window 61a via the communication manager 56 under the control of the window manager 64, etc.

The client 51 identifies all or some of nodes in the object network displayed on the window 61a, and issues an instruction to the system. In response to this instruction, the communication manager 56 interprets the contents of the instruction, and makes the server 53 call a template corresponding to the instructed noun object. The template will be described later.

On the data window (II) 62b, for example, restriction data which exists in correspondence with the noun object, etc. is displayed, the client 51 selects the restriction data, and the server 53 executes the process corresponding to the instruction of the client 51 based on the result of the selection. The result of the execution is displayed on the data window (I) 62a, and evaluated by the client 51. Then, the next instruction is issued.

The information processing device, which uses the common platform shown in FIG. 7, takes advantage of a data display format that is most suitable for a user as the client 51 on the window 54. The common platform 52 converts the data into a data format for a process within the information processing device, which makes it easy for the user to use the system.

For a human being as the client 51, a data format such as a schematic like a graph or a picture is easier to understand than a text format, and also easy to issue an instruction. Especially for a point or a line, it is desirable to issue an instruction on the data window 62 directly or with a mouse.

In the meantime, for a computer as the server 53 side, processing efficiency is more improved if a point is numeralized as coordinates of (x,y), and a line is represented by pixels from the starting point to the end point as a list format.

Namely, between the common platform 52 and the client 51, it is desirable to display data which represents a point or a line as the point or the line unchanged, and to enable an instruction to be issued while referencing the point or the line. In the meantime, between the common platform 52 and the server 53, it is desirable to enable data to be identified in an index format, and to collectively transfer or combine and process, for example, data resultant from the instruction issued from the client 51.

Data which represents a graphic or a picture is displayed as the graphic or the picture unchanged between the common platform 52 and the client 51, whereby the client 51 can issue an instruction by using the graphic or the picture. At the same time, between the common platform 52 and the server 53, a representation format by which the data can be identified with a list structure or raster structure is used.

For a data element, a representation format that enables an instruction using the name of a data element is adopted between the common platform 52 and the client 51, and a representation format that identifies a data element by using its name header is adopted between the common platform 52 and the server 53.

In the preferred embodiment according to the present invention, the information processing device, which comprises the common platform 52 and the server 53 and is shown in FIG. 7, adopts a WELL system using a functional language abbreviated to a WELL, in which data and a process corresponding to the data are handled as objects, and information processing is executed with an object network that represents the objects as a graph.

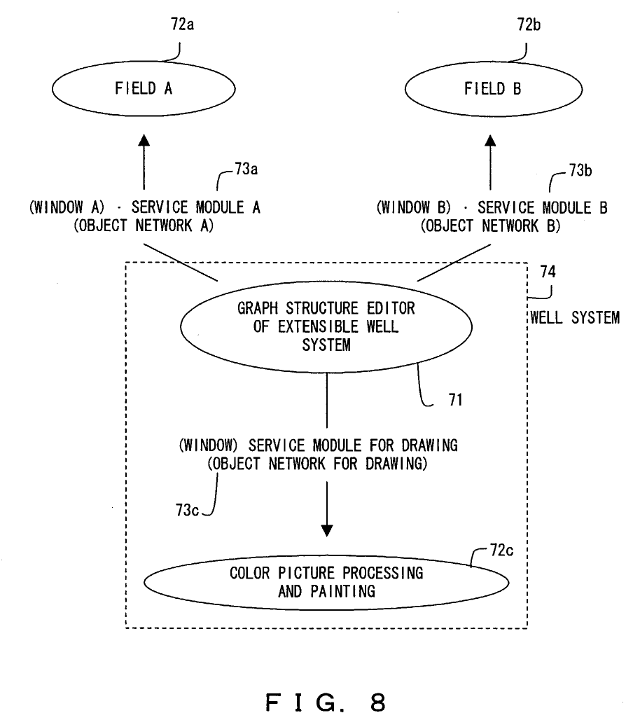

FIG. 8 explains the relationship between the WELL system and the object network. In this figure, 72a, and 72b respectively indicate particular processing fields. Especially, 72c indicates specific object network of a color picture generation/coloring process field. 73a, and 73b respectively indicate object networks corresponding to the fields 72a, 72b. Finally, 73c indicates an object network for drawing combined with a service module for drawing. A graph structure editor 71 is a graph structure editor of an extensible WELL system, which can cope with various object networks.

If an object network which corresponds to a particular field is provided to the functional language abbreviated to a WELL, the process of the object network is executed without a program. Additionally, this language is a window-oriented language. A window is used as an interface with a client, thereby implementing a client-server model.

In FIG. 8, a window required for the color image generation/coloring processing field 72c, and the object network 73c corresponding to the service module which executes the corresponding process are combined, whereby the WELL system becomes a WELL system 74 corresponding to the color picture generation/coloring processing field 72c. The object network 73a or 73b, which corresponds to a different field, is combined, whereby the system corresponding to the field 72a or 72b is generated. 74 provides a picture processing method.

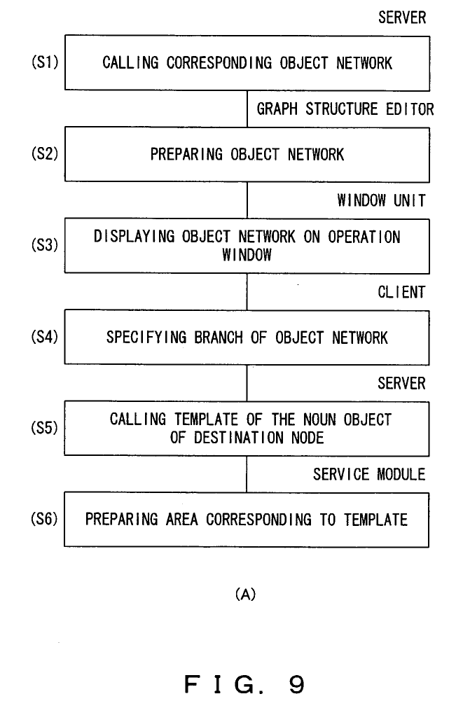

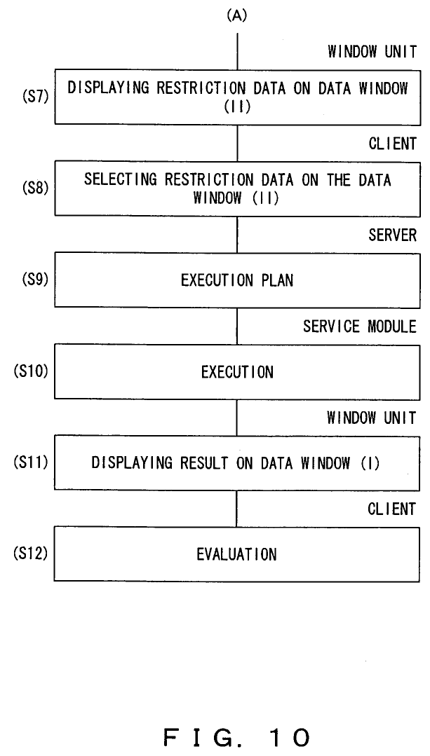

FIGS. 9 and 10 are flowcharts showing data processing using an object network. Once the process is started in FIG. 9, a corresponding object network is first called by the server 53 shown in FIG. 7 in step S1. For example, if the process of the color picture generation/coloring processing field is executed, the object network shown in FIG. 4 is called. The called object network is stored in the working area of the WELL kernel 63 by the graph structure editor 67 in step S2. In step S3, the window manager 64 and the display manager 65 are activated by the WELL kernel 63, and the object network is displayed on the operation window 61a via the communication manager 56.

The client 51 specifies part of the displayed object network, for example, a branch, and issues an instruction to the system in step S4. This instruction is identified by the communication manager 56, and a template of a destination node, namely, a noun object at the tip of the branch is called by the server 53 via the WELL kernel 63 in step S5, and an area corresponding to the template is prepared by the service module 57 in step S6.

Then, in step S7 of FIG. 10, restriction data corresponding to the template is extracted on the common platform 52 side, and displayed on the data window (II) 62b. Particular restriction data is then selected by the client 51 from among the displayed restriction data in step S8. The result of the selection is identified by the communication manager 56 and transmitted to the server 53 via the WELL kernel 63, and an execution plan is generated in step S9.

According to the generated execution plan, the process specified by the user, for example, a process such as lining, coloring, etc. is executed by the service module 67 in step S10. Its result is displayed on the data window (I) 62a in step S11, and the process result is evaluated by the client 51 in step S12. Then, the next instruction is issued.

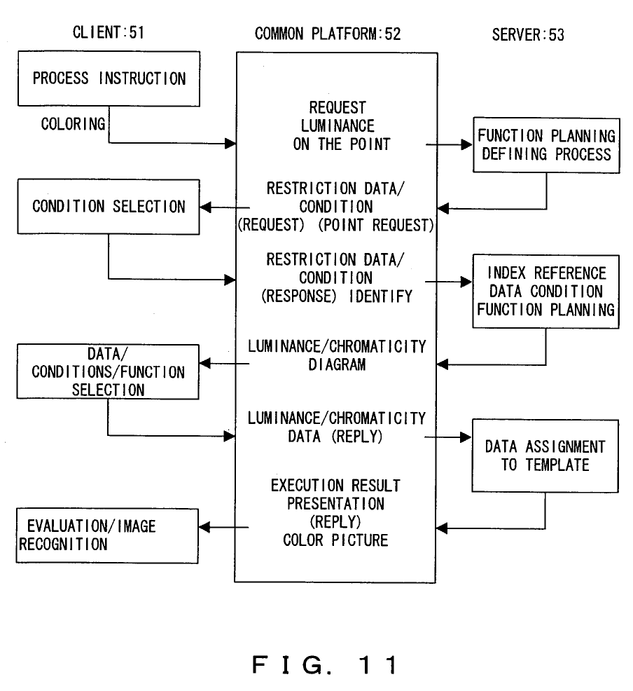

FIG. 11 shows a processing method in the case where the color picture generation/coloring process is performed by the information processing device comprising the common platform. Here, a process for generating “luminance on the point”, which provides luminance to a point in the attribute network on the right side of the object network described with reference to FIG. 4, is explained.

When a request to generate “luminance on the point” is first issued as a process instruction from the client 51 to the server 53 via the common platform 52, a request to return information indicating to which point luminance is provided is issued from the server 53 as a restriction data/condition required for planning function execution. Then, identification for the point is made as a condition selection by the client 51 side. Specification, that is, the identification of that point is made via the common platform 52 by referencing an index of a template on the server 53 side, as will be described later. Then, a request to select luminance data to be put on that point is issued to the client side as data required for planning the function execution.

This request is provided to the client 51 side as a luminance/chromaticity diagram, and luminance/chromaticity data to be put on the point in the luminance/chromaticity diagram is returned from the client 51 side as a data/condition/function selection to the server 53 side. On the server 53 side, that data is assigned to the template to execute the process, and a color picture as an execution result is presented to the client 51 side via the common platform 52. The client 51 side evaluates the execution result with picture recognition, and issues the next process instruction.

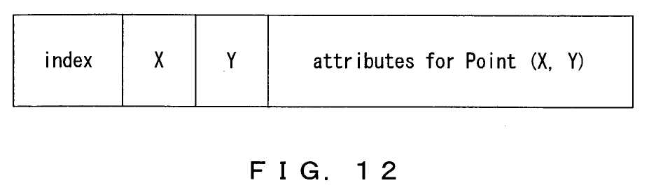

FIG. 12 exemplifies a template used in the process performed on the server 53 side. This template indicates, for example, the template corresponding to the noun object of the point shown in FIG. 4, and is formed to store coordinates X and Y of that point on a display screen, an index for identifying the point without using the coordinates on the system side, attribute data for the point, such as luminance, chromaticity data, etc.

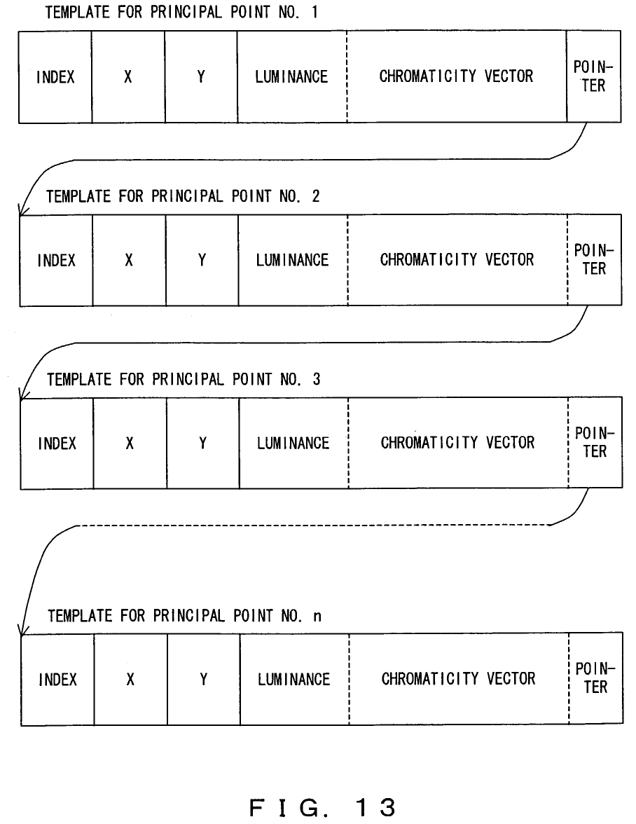

FIG. 13 exemplifies the template corresponding to, for example, the noun object named “line segment” shown in FIG. 4. The template for a line segment stores a pointer which points to one different point in addition to luminance and a chromaticity vector of each of principal points in an attribute data storage area in a template for each of the principal points No. 1, No. 2, . . . , No. n, which configure the line segment. With these pointers, all of these templates are defined as the template for the single line segment.

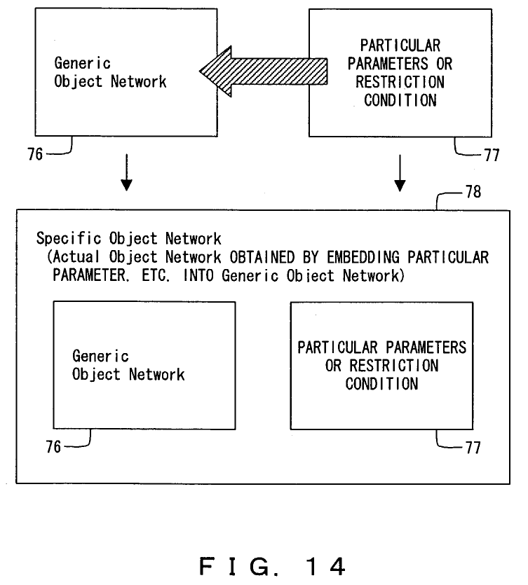

FIG. 14 explains a method generating a specific object network as a concrete object network for executing a particular process from a general generic object network. For example, as a formula to which a generalized variable is given is prepared in mathematics, a generic object network 76 to which a generalized parameter, restriction condition, etc. are given is prepared. Then, a parameter and a restriction condition 77 for making a particular process executed are embedded in the generic object network 76, so that a specific object network 78 for the particular process is generated.

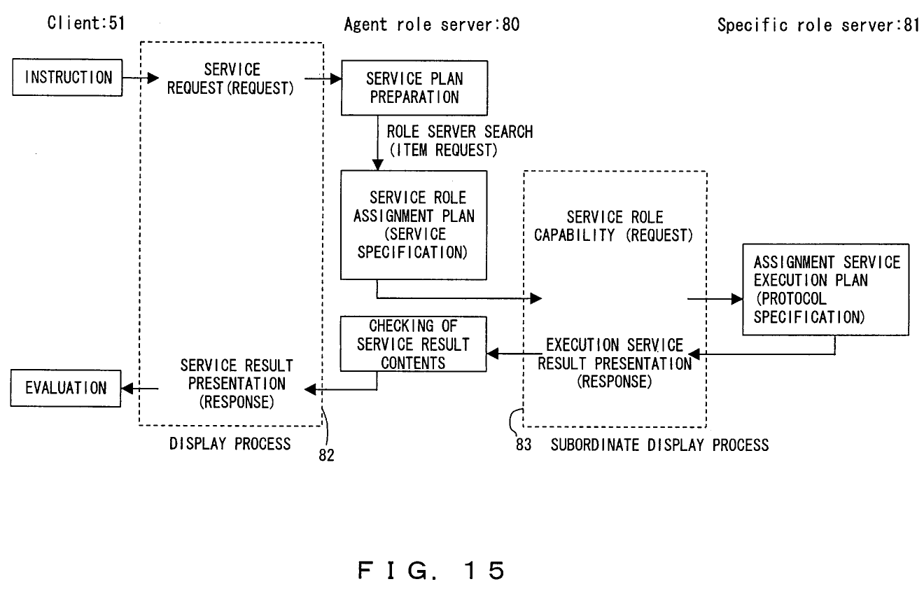

FIG. 15 is a block diagram showing the configuration of an information processing device comprising an agent. In contrast to FIG. 7, an agent role server 80 is comprised between a client 51 and a specific role server 81 corresponding to the server 53 shown in FIG. 7. In this figure, the agent role server 80 is arranged to play a role, for example, like a travel agent between the client 51 and the specific role server 81 that actually executes a specific process.

A display process 82 and a subordinate display process 83 are display processes that make a necessary data display, etc. respectively between the client 51 and the agent role server 80, and between the agent role server 80 and the specific role server 81. A service request and its response are made by using the display process 82 between the client 51 and the agent role server 80.

The agent role server 80 prepares a service plan according to an instruction of the client 51, searches for a server to execute that role, namely, the specific role server 81, generates a service role assignment plan, and issues a request to execute the role capability to the specific role server 81 via the subordinate display process 83.

The specific role server 81 executes a process corresponding to the assigned service execution plan, and presents the result of the process to the agent role server 80 via the subordinate display process 83. After checking the contents of the service result, the agent role server 80 presents the result to the client 51 via the display process 82.

The display process 82 and the subordinate display process 83, which are shown in FIG. 15, are respectively implemented by the formats of the common platform explained with reference to FIG. 7. It can be considered that the agent role server 80 is implemented as one of the service modules 57.

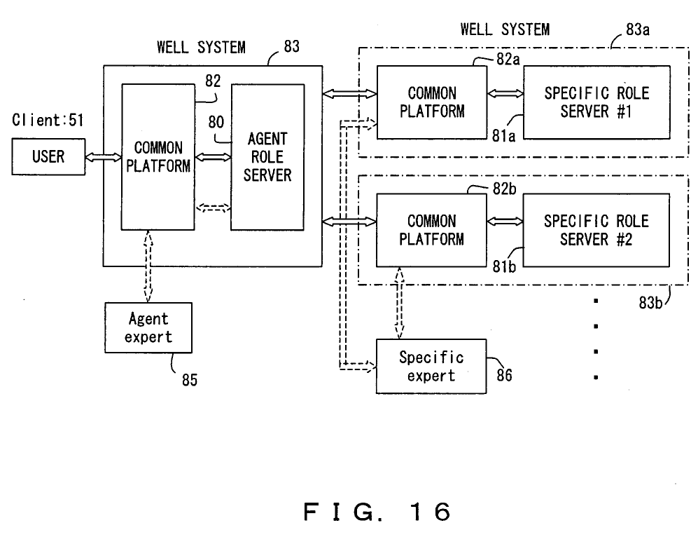

FIG. 16 is a block diagram showing the configuration of an information processing device in consideration of the existence of an expert. Unlike FIG. 15, a plurality of specific role servers 81a, 81b, . . . are arranged as specific role servers in this figure. The specific role servers separately execute particular services respectively assigned. Their results are integrated by an agent role server 80, and a process according to an instruction of a client 51 is executed. The agent role server 80 configures a WELL system 83 along with a common platform 82. For example, the specific role server 81a configures a WELL system 83a along with a common platform 82a.

In FIG. 16, an agent expert 85 supports an information exchange between the client 51 and the agent role server 80, and a specific expert 86 supports an information exchange between the agent role server 80 and the plurality of specific role servers 81a, 81b, . . .

The client 51 is, for example, a human being as a user. However, the agent expert 85 or the specific expert 86 is not limited to a human being, and can be implemented by a processing unit having an intelligent capability.

In FIG. 16, the client 51 makes a request to solve a particular problem to the agent role server 80. When this request is made, the agent expert 85 supports the generation of a service plan of the agent role server 80 by configuring a generic object network in correspondence with a process to be executed by the agent role server 80, and by generating a specific object network, generally, a plurality of specific object networks which provide concrete object networks into which particular parameters and restriction conditions are actually embedded, as a specialist.

Similarly, the specific expert 86 supports the process of each of the plurality of specific role servers by designing an object network for implementing a service assigned to each of the plurality of specific role servers, and a template associated with the object network in correspondence with the service plan generated by the agent role server 80.

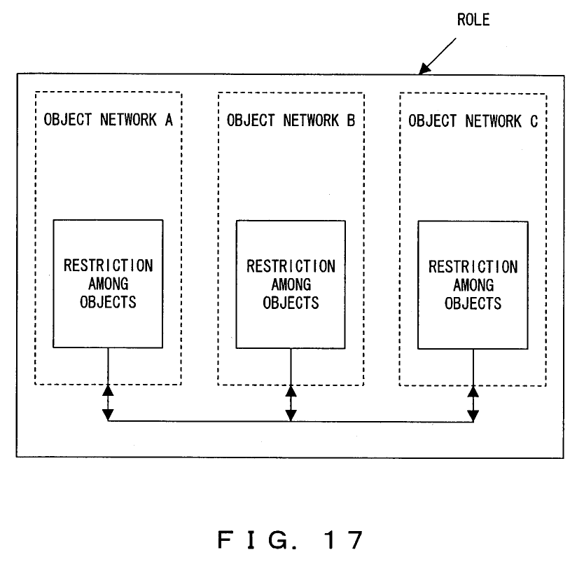

The role capability and the interaction capability of the information processing device that uses an object network and a common platform are described next. FIG. 17 explains the definition of a role. As shown in this figure, a role is defined as a structure of object networks, and serves as a unit of an execution process. A name is given to a role, which is referenced inside/outside the system with the name.

The relationship among a plurality of object networks within one role is stipulated as a relational expression of attribute values of objects in correspondence with restrictions defined for the objects which configure each of the object networks. Note that a role can be configured by only one object network.

For the information processing device according to the present invention, a cooperative operation among a plurality of roles is required, for example, to satisfy an instruction from a user by performing an execution process by a plurality of roles in an overall manner. To perform the cooperative operation, an interaction capability among the roles must be enhanced, and a free communication form must be provided. Additionally, to satisfy a request from a user, an efficient interaction capability must be provided between the user (that can be considered as one support role) and a system providing a service. The interface capability between the user and the system is implemented by a common platform as described above.

Such a data processing device uses two types such as event driving and data driving as elements of an efficient interaction capability between a user and a system, or among a plurality of roles.

Firstly, as the event driving, for example, a client issues a request to implement a noun object on a common platform to the system. On the system side, a server that receives the request from the common platform returns its execution result to the client side as a response.

Additionally, as the data driving, a request to set an attribute value is issued from the system to the client side, if the value corresponding to the attribute is not defined within a template which corresponds to a currently handled noun object within the system. When this request is issued, a display that the attribute value is undefined is made on a data window, and a request to define the required attribute value is made to the client side on the data window.

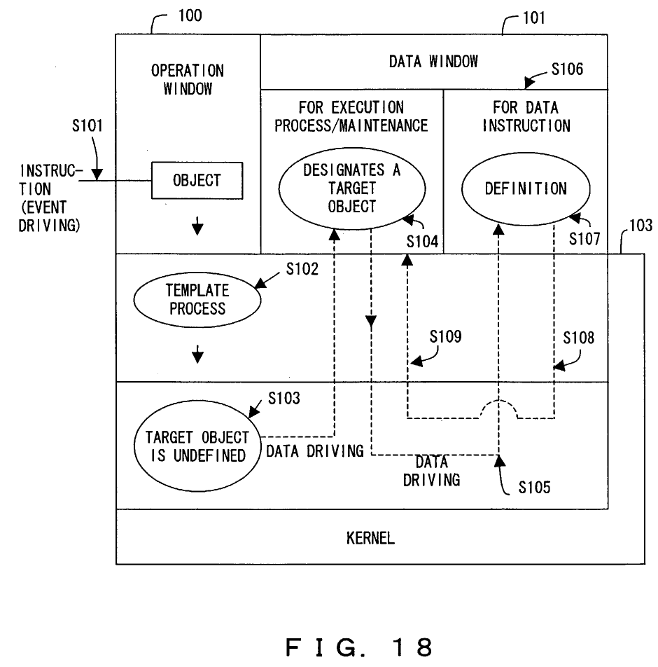

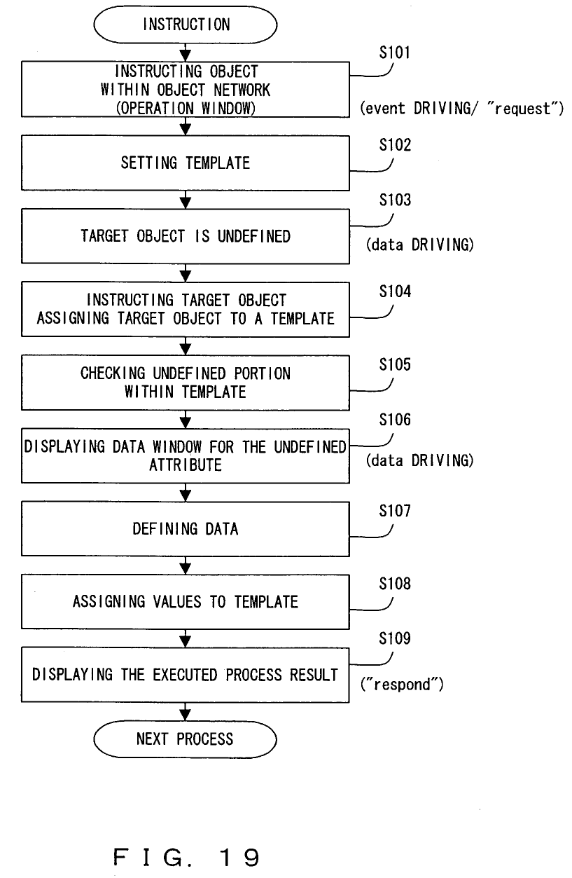

FIG. 18 explains the movements of the process within a WELL system for an explanation of an interaction capability based on such event driving and data driving. Additionally, FIG. 19 is a flowchart showing the process of the interaction capability based on the event driving and the data driving in correspondence with FIG. 18. The process based on the event driving and the data driving is described with reference to FIGS. 18 and 19.

Firstly, in step S101 of FIG. 19, a client, for example, a user instructs as a request to the system, for example, one object within an object network displayed on an operation window 100 of a common platform shown in FIG. 18. This corresponds to the event driving (request). In response to this user instruction, a template corresponding to this object is set in step S102.

Here, if a specific name of the target object corresponding to the set template, etc. is undefined, this is determined by a kernel 103 of a WELL system. Then, a request to instruct the target object is issued to the client as data driving in step S103. For example, the case where the name of an object within the specific object network, which corresponds to the object configuring the generic object network, is undefined as explained with reference to FIG. 14, corresponds to this case.

The client instructs the target object on the data window 101, and the target object is assigned to the template in step S104. Furthermore, in step S105, the kernel 103 checks whether or not an undefined attribute value exists within the template. If an undefined attribute value exists, a display for requesting the client to input the undefined attribute value is made on the data window as the data driving in step S106.

The client defines the undefined attribute value on the data window 101. This data definition is received by the system side in step S107. In step S108, this attribute value is assigned to the template. The WELL system then executes a process by using the contents of the template to which the attribute value is assigned, and displays the result of the process on the data window in step S109. Here, the process (respond) corresponding to the client instruction is terminated.

As described above, with an interaction capability based on event driving and data driving, a user-friendly and efficient interface can be implemented between a user and the system. Additionally, a communication capability for supporting a cooperative operation among a plurality of roles, for example, between an agent role server and a specific role server, etc. can be implemented. The interaction capability is implemented by using the kernel of a WELL system, thereby coping with a variety of systems, especially, a software architecture considering a personal computer system.

Furthermore, if a cooperative operation is performed among a plurality of roles, it is desirable that an interaction capability based on common data is provided between a main role which executes a role capability as a predominant capability, and a support role which provides a service capability for supporting the main role. The main role operates under a certain environment associated therewith, and data of this environment must be continually monitored. If the support role and the main role share the environment data, and if it is possible to notify the main role of the characteristic of a change as an interrupt when the change occurs in the environment data, the main role can perform an operation that matches the change occurred in the environment.

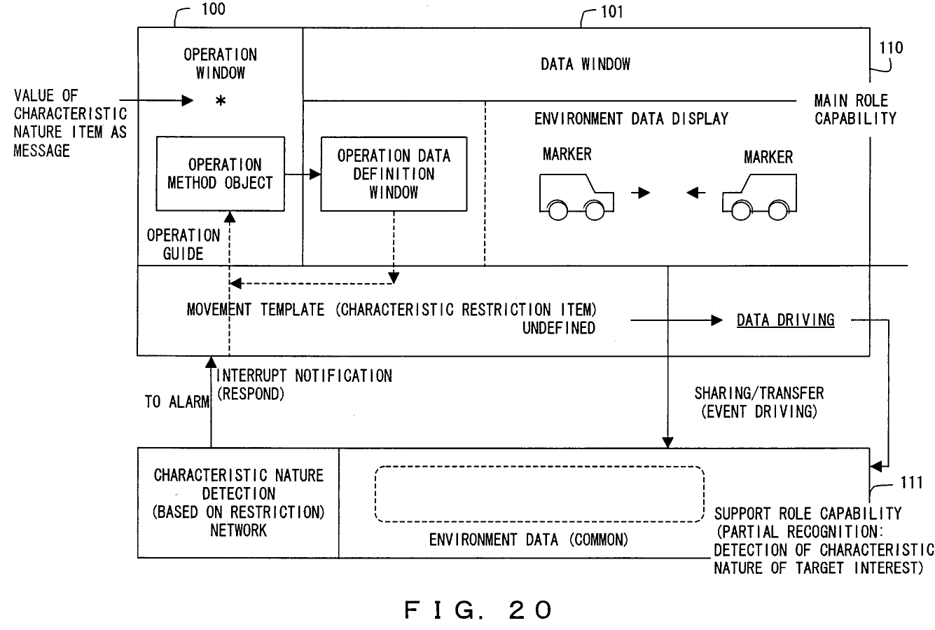

FIG. 20 explains the interactive capability between a main role capability and a support role capability based on environment data. In this figure, semiautomatic steering operations of two automobiles are considered as an example. Here, assume that systems are respectively embedded into the two automobiles, which are made to run a course on which they can possibly collide with each other.

A main role 110 embedded into one of the automobiles comprises an object of a semiautomatic steering operation method, and this object is displayed on an operation window 100 of a common platform. Additionally, environment data is displayed on a data window 101.

When a change occurs in the displayed environment data, this is transferred to a support role 111 as event driving. The support role 111 detects the characteristic nature of the environment data. This detection is made by an object network for detecting a characteristic nature, which is comprised by the support role 111.

For example, if a characteristic nature that the two automobiles get too close to avoid a collision is detected, the support role 111 notifies the main role 110 of this nature, namely, the support role returns the nature to the main role as a response with an interrupt. The main role 110 sets a movement template corresponding to the steering operation method object in correspondence with this interrupt.

If an undefined portion exists in the contents of the movement template, and for example, if data indicating in which direction and how far the automobiles are to be moved is undefined, a request to set the undefined data is made with data driving. If steering operations are not semiautomatic, the request to set the undefined data is made to a user, namely, a driver. However, since the steering operations are semiautomatic in this case, the request is made, for example, to the support role 111. The support role 111 detects the necessary characteristic nature from the environment data, and provides the requested data in correspondence with a detection result. When this data is assigned to the movement template, the main role 110 starts an interaction capability with the user so as to make the user perform an actual steering operation by using the operation method object as an operation guide.

Furthermore, to smoothly perform a cooperative operation among a plurality of role capabilities, one-to-multi broadcasting from a main role capability which plays a certain role to subordinate role capabilities which play associated roles must be enabled.

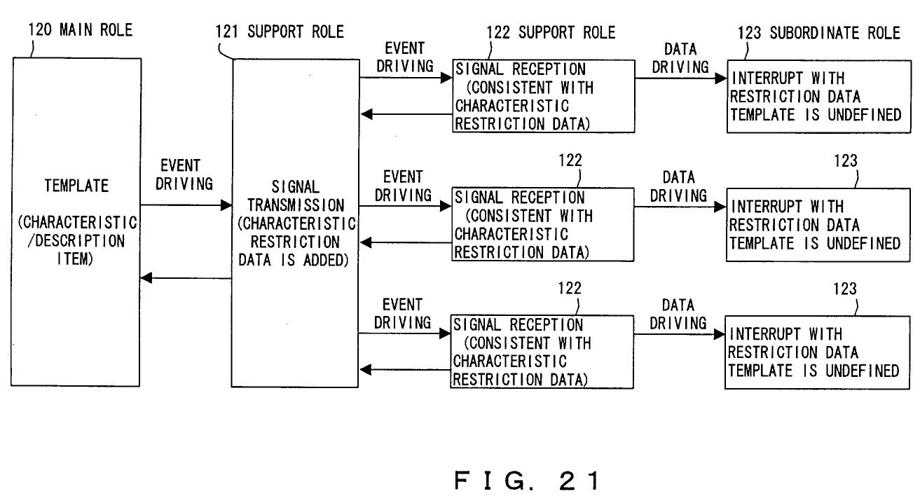

FIG. 21 explains one-to-multi broadcasting from a main role capability to subordinate role capabilities. This figure assumes that a main role 120 and a plurality of subordinate roles 123 operate cooperatively as an entire system. The main role 120 makes one-to-multi broadcasting to the plurality of subordinate roles 123, thereby controlling the operations of the subordinate roles 123. To implement this, a support role 121 broadcasts a signal, to which characteristic restriction data is added, to a plurality of support roles 122 based on event driving from the main role 120. The plurality of support roles 122 receive the broadcasting, and extract the name of the role capability at the broadcasting source, and the restriction data.

The plurality of subordinate roles 123 have a template including an undefined portion, receive the restriction data from the support roles 122 with an interrupt based on data driving, and executes role capabilities subordinate to the main role 120 in correspondence with the restriction data.

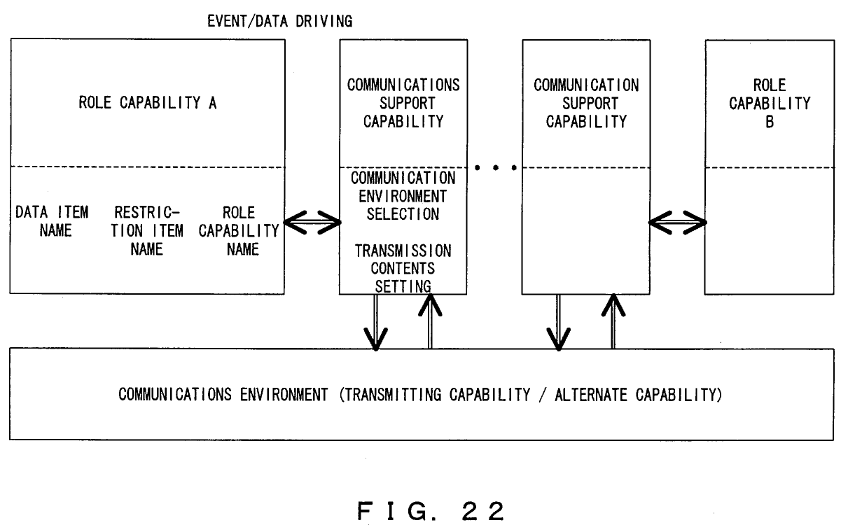

FIG. 22 explains a communication among role capabilities. In this figure, role capabilities A and B, and a plurality of role capabilities not shown can communicate with one another via a communication environment. A communication support capability for supporting a communication is provided among the role capabilities A and B, and the communication environment. A communication among the roles and the environment is made by an interaction capability based on event driving and data driving.

For example, B is specified from the role capability A as a partner role capability name, and contents such as a data item name, a restriction item name, etc. are notified to the role capability B via the communication support capabilities, so that the execution process of the role capability B is controlled. The communication support capabilities perform operations such as a selection of the communication environment, setting of contents to be transmitted, and the like. Among the plurality of role capabilities, a partner role capability can be selected and communicated freely.

Up to this point, the object network and the common platform have been explained. Information processing for realizing an intention is described next.

An intention targeted by the present invention indicates not a relatively small and partial instruction to, for example, put a point or generate a point sequence on the screen, which is described with reference to FIG. 4, but a relatively large intention such as an intention of a user, namely, a driver in the case where semiautomatic steering operations are performed in two automobiles while avoiding a collision with each other, which is explained with reference to FIG. 20.

Types of the intention are broadly classified into three types such as a common intention, a contradictory intention, and an independent intention. The common intention is an intention possessed in common by both of clients, for example, human beings, such as the above described intention to perform the semiautomatic steering operations while avoiding a collision each other, which is possessed by users of two systems, such as drivers of the automobiles.

The contradictory intention is possessed, for example, in the case where a bird flying in the sky has an intention to find a fish swimming in the sea, and to eat the fish, whereas the fish has an intention to safely escape from the bird without being captured by the bird. The contradictory intention is considered to be possessed also in the case where a gorilla meddles with an owl without hurting the owl in correspondence with the movement of the owl, and makes general learning via a play by, whereas the owl learns a method of safely escaping from the gorilla according to the mutual movements during that time. The strategy of the gorilla is not capturing or killing of the owl, but the concept of a goal intention to stop an action to the verge of capturing or killing, and to restore to the original state. This can be implemented in such a way that the support role possessed by the gorilla grasps that the reaction of the owl reaches the limit as a characteristic restriction.

The independent intention is an intention possessed by a human being in the case where he or she performs an operation with a certain goal regardless of the intention of a user of a different system, for example, the intention of a different human being, unlike the common intention and the contradictory intention. This is an intention possessed by a human being, for example, in the case where drawing is made as described above, or a moving picture is generated by integrating multimedia information.

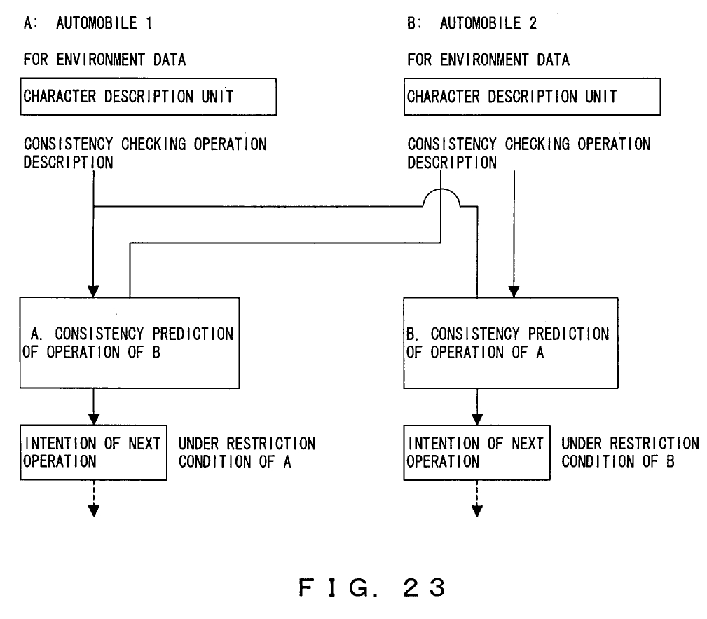

FIG. 23 explains a consistency prediction process performed, for example, in the case where users A and B have a common intention to perform semiautomatic steering operations of automobiles while avoiding a collision. In this figure, both of the users A and B mutually predict the steering operation of the other automobile based on a result of a characteristic description of each environment data, and performs a consistent operation for avoiding a collision, which is stipulated by a restriction condition, as the next operation.

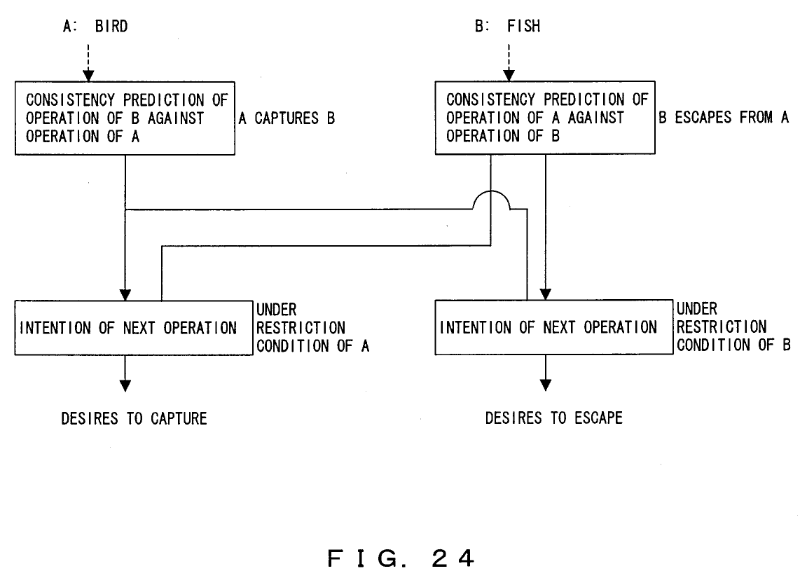

FIG. 24 explains a consistency/inconsistency prediction in the case where two parties mutually have contradictory intentions, like the above described bird and fish. In this figure, a bird attempts to catch a fish, and the fish attempts to escape from the bird. Therefore, the bird predicts the path that the fish is to take, whereas the fish predicts the path that the bird is to approach. Namely, the bird and the fish mutually perform an operation against predictions. However, their next operations are performed under restriction conditions respectively for the bird and the fish in this case, and performed with the bird goal to capture the fish, and with the fish goal to escape from the bird.

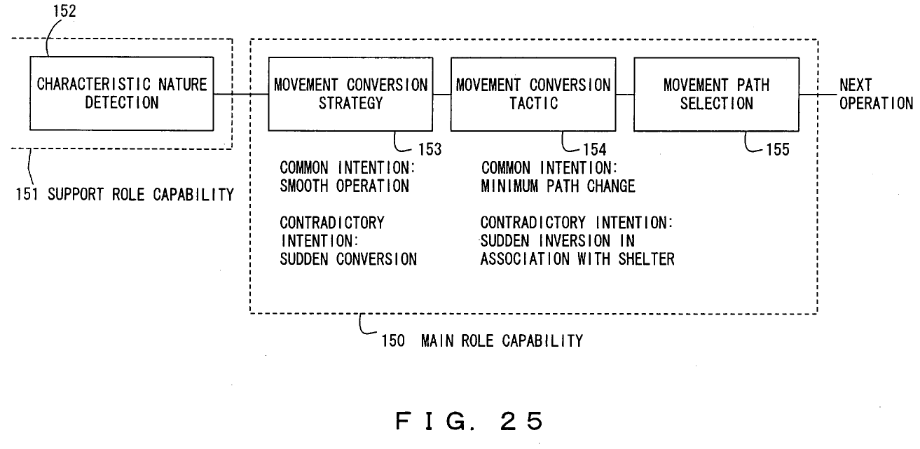

In the information processing for realizing an intention, it is extremely vital to decide a strategy, that is, a tactic of what operation to perform next based on a detection result of a characteristic nature such as road status, etc. namely, based on a restriction condition so as to avoid the collision of the two automobiles. FIG. 25 explains movement conversion as the next operation based on a strategy and a tactic for the above described common intention to avoid the collision of the two automobiles, and the contradictory intentions of the bird and the fish.

In FIG. 25, decision of the next operation based on the strategy and the tactic is made by a main role capability 150 which plays a main role, and detection of characteristic natures of environment data, etc. is made by a support role capability 151 which plays a support role. Firstly, detection 152 of the characteristic natures such as the status of a road, the speed of the other automobile, etc. is made by the support role capability 151, and its result is provided to the main role capability 150. The main role capability 150 first decides a movement conversion strategy 153. In the case of the common intention to avoid the collision of the two automobiles, maintaining an operation as smooth as possible at the time of movement conversion is the strategy 153. In the case of the contradictory intentions of the bird and the fish, sudden movement conversion is adopted as a strategy so as to be contrary to the prediction of the other automobile.

Then, the main role capability 150 decides a movement conversion tactic 154. This tactic is taken to minimize a path change in order to avoid, for example, a shock given to a passenger as much as possible in the case of the common intention. In the case of the contradictory intentions, a tactic with which the fish performs a sudden inversion operation in association with a shelter such as the shade of a rock, to which the fish escapes, is taken. A movement path selection 155 is made according to such a tactic, and the next operation is decided.

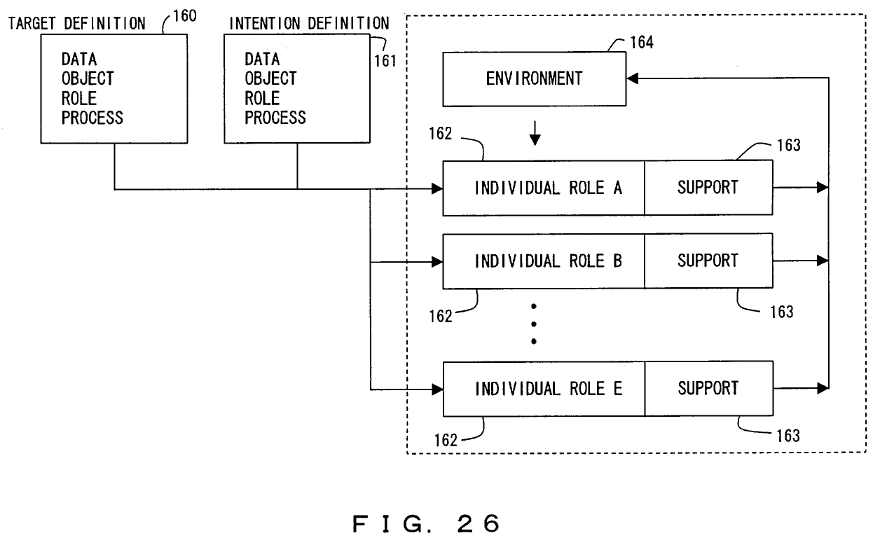

FIG. 26 is a block diagram showing the outline of the entire structure of an information processing device for realizing an intention. In this figure, a target definition 160 and an intention definition 161 are made. The target definition 160 is, for example, two automobiles making two-way traffic, and the contents of the intention definition 161 is that the two automobiles attempt to perform semiautomatic steering operations while avoiding a collision each other. The definitions are respectively made by using a data model given in a format such as a template, etc., and an object model given in a format of an object network, noun objects and verb objects, a role model represented as a set of object networks as explained with reference to FIG. 17, and a process model which indicates integrated many roles that perform a cooperative operation, as will be described later.

According to the contents of the target definition 160 and the intention definition 161, pluralities of individual roles 162, and support roles 163 which respectively support the individual roles perform a process for realizing an intention. The respective support roles 163, for example, observe an environment 164, detect characteristic natures, and provides the detected characteristic natures as restriction data for the individual roles 162.

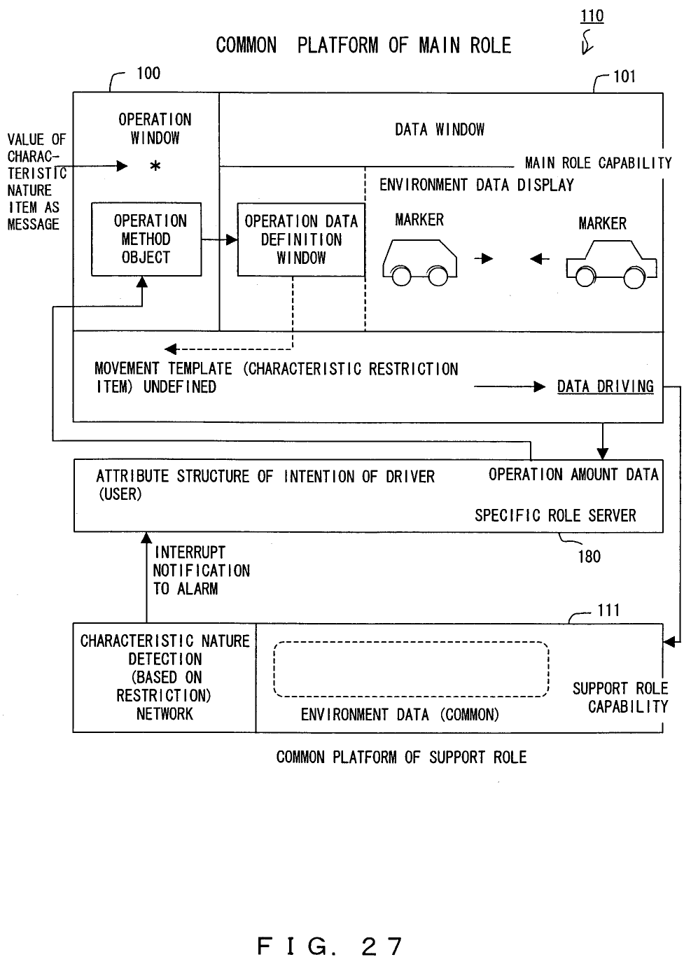

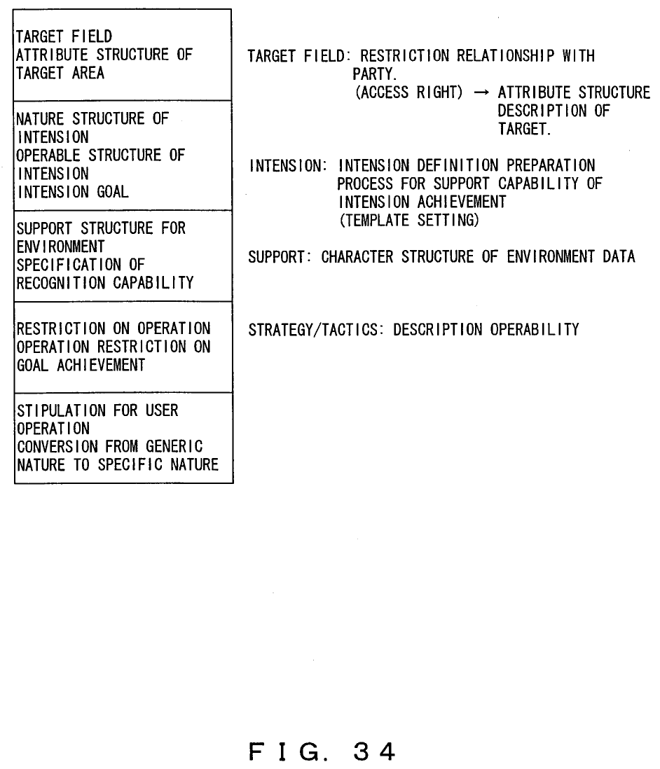

FIG. 27 explains the process for realizing an intention with data driving. In this figure, a specific role server 180 which executes, for example, a user role is comprised in addition to a main role capability 110 and a support role capability 111, which are similar to those shown in FIG. 20. The main role capability 110, which corresponds to an agent role server, requests the specific role server 180 to return operation amount data, namely, operation amount data of a brake or a steering wheel, which corresponds to an operable structure to be described later with reference to FIG. 34 as data driving, and the operation amount data is returned as a response to the main role capability 110 in correspondence with the attribute structure of the intention of a driver.

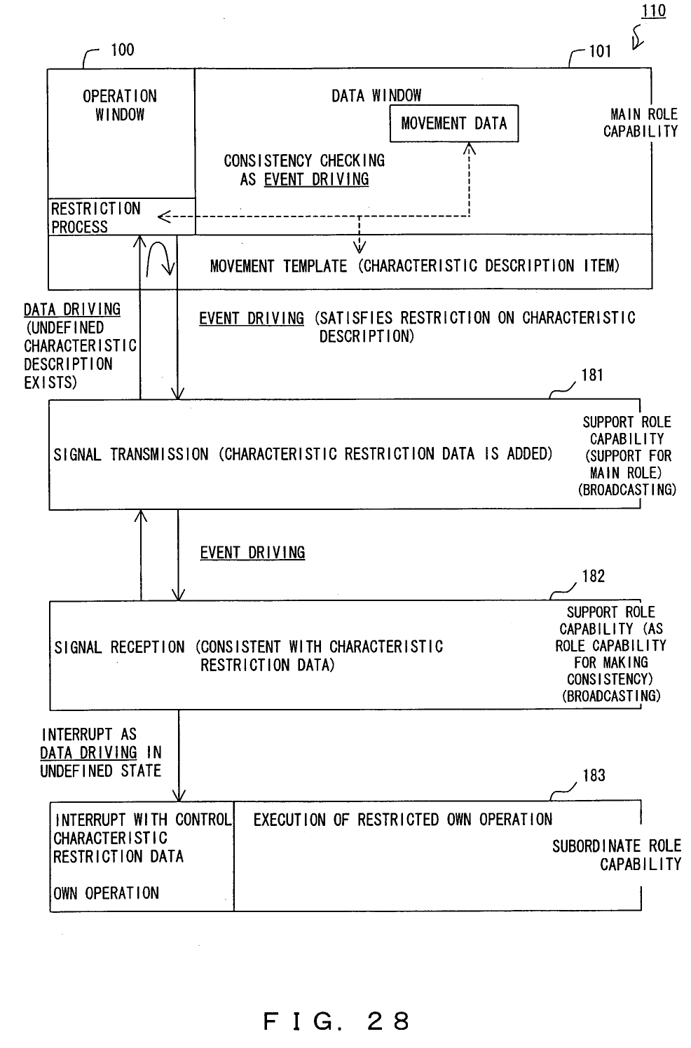

FIG. 28 explains a hierarchical structure of event drivings in a cooperative process performed with a broadcasting capability. In this figure, a support role capability 181 makes broadcasting for supporting a main role capability 110, and a support role capability 182 receives the broadcasting, and controls a subordinate role capability 183. Event driving from the main role capability 110 to the support role capability 181, and event driving from the support role capability 181 to the support role capability 182 form a hierarchical structure.

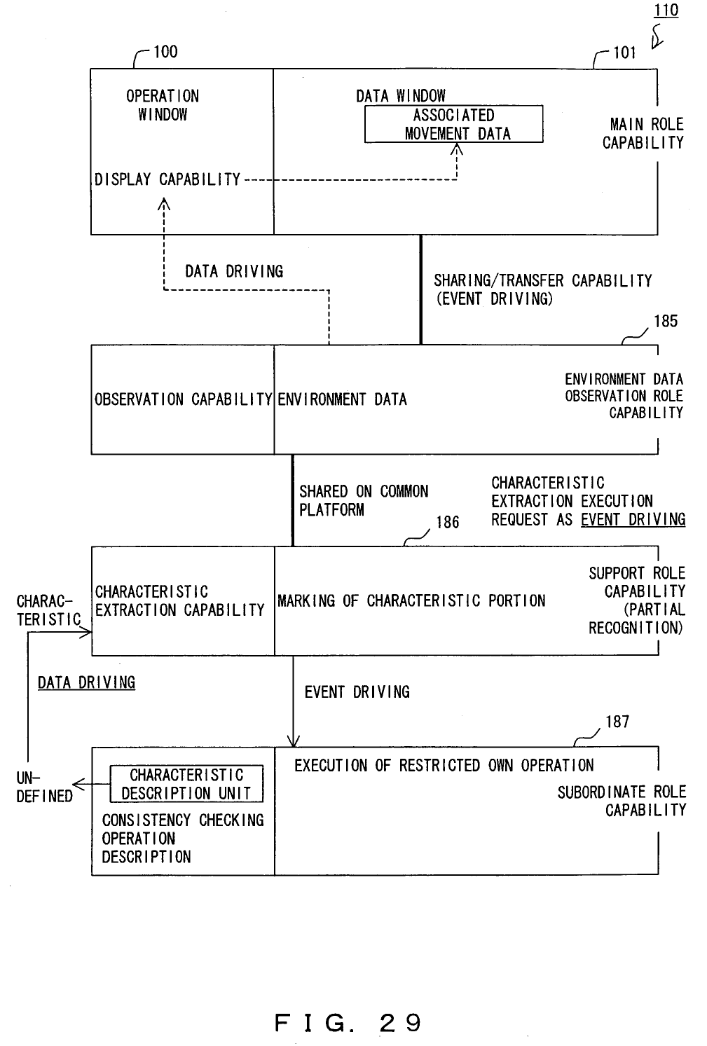

FIG. 29 explains a cooperative process performed by a partial recognition capability of environment data. In this figure, entire environment data is observed by an environment data observation role capability 185, and a support role capability 186 for further recognizing a partial movement, etc. is comprised to make partial recognition of environment data. The support role capability 186 makes event driving, etc. for a subordinate role capability 187 depending on need.

A hierarchical structure of objects in this preferred embodiment is described next. In this preferred embodiment, the hierarchical structure of objects is configured by four models such as a data model, an object model, a role model, and a process model.

Firstly, for the data model, which is positioned lowest in the hierarchical structure, its attribute structure is planned, for example, as the template shown in FIG. 12, and input to a kernel of a WELL system. Its input format is a list format of data. The kernel sets a process request in a working area for executing a service in correspondence with event driving, and specifies the position of a cell, for which data definition must be made, within the template with data driving during the execution of the process.

The object model is classified into three types such as a format model, a characteristic model, and an object network model. The format model is a model which formally represents the pattern of a noun object or a verb object. This model is, for example, “point”, etc. shown in FIGS. 4A and 4B.

As a noun object as the format model, a common noun, a proper noun, and a generic noun obtained by making a common noun aggregated and abstract are available. Normally, a common noun is used as a name in an object network, and a list structure representation is made by an expert for a template of a data model, and stored in a WELL kernel. In this stage, the common noun has an attribute as an indefinite article “a”. For example, if a common noun is instructed with event driving from a user, an operation for preparing a data definition is performed. It can be considered that the common noun is converted into a proper noun having an attribute as a definite article “the”, when the operation for making a data definition is performed, for example, by the user in correspondence with data driving from the system.

A verb object as the format model pairs with a noun object. Namely, there arises a relationship, for example, between a subject and a predicate. A verb service execution preparation operation and a service execution operation are performed during the execution process of an object network.

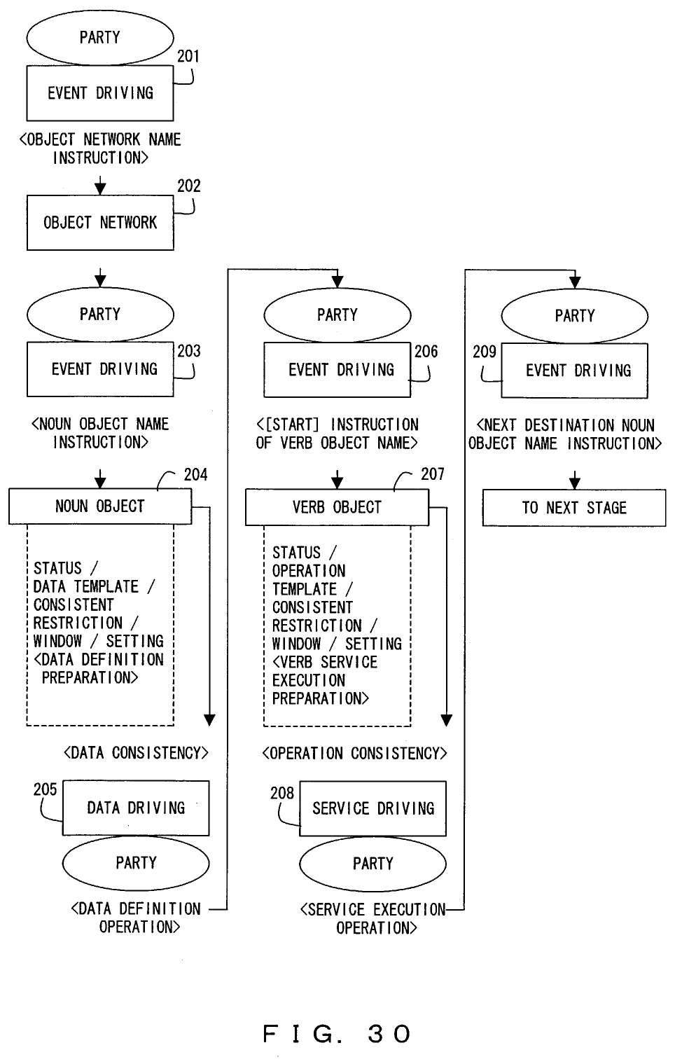

FIG. 30 explains a user process performed for an object network. In this figure, a party, for example, as a user instructs the name of an object network 202 with event driving 201, and then instructs the name of a noun object 204 within the object network 202 with event driving 203.

Data consistency is then checked by the system in correspondence with the instructed noun object 204. For example, if undefined data exists, a request to perform a data definition operation is issued to the party to define the data with data driving 205 from the system.

When the undefined data is defined by the party, and the name of a verb object 207 is instructed from the party, for example, the user with event driving 206, a start instruction is issued to the system by pointing to the object. The system checks operation consistency in correspondence with this instruction, and makes service driving 208 for getting a necessary service executed as event driving for the party to execute the service, so that the service execution operation is performed by the party.

Then, the party, for example, as the user instructs the name of a noun object to be the next destination with event driving 209, and the process in the next stage is executed.

A characteristic model of the object model is a model that represents a characteristic based on the attribute value of a noun object, for example, “colored point” which configures the object network for drawing, and a restriction condition according to an environment is added to.

For example, if a WELL kernel requests a different server such as a specific role server to execute a service associated with the position, in which contents of a consistent restriction condition item within a template structure of an object is stipulated, with event driving, data stipulating a characteristic model is requested from the server with data driving. This process corresponds to a communication among a plurality of servers, and is one of the tasks of the WELL kernel.

Next, the object network is stored in a working area managed by the WELL kernel as a graph structure that has the name of a noun object, which is put into a template as a data model, as a node, and the name of a verb object as a branch, and displayed on a common platform. To implement this, an expert must represent a noun object and a verb object, which are represented as a format model or a characteristic model, in a specification format, and prepares the objects as a graph structure so as to enable an execution process. Therefore, a graph structure editor for describing the graph structure, and for displaying the graph structure on the common platform is required.

If an object has an abstract name, an object network for making its abstract nature specific, and a set of data to be provided to the object network become necessary. Accordingly, a process model to be described later and its associated mechanism are required. An object network model has the name of the network as a header, and can be referenced with the name. The object network model can be also referenced by comprising a capability for indexing a noun object and a verb object as constituent elements.

The third model configuring the hierarchical structure of objects is a role model. The role model is a model corresponding to the role capabilities described with reference to FIGS. 20 to 22. This is also a model representing contents, which are to be executed by a party in an environment, as a set of object networks.

Accordingly, the role model has a name as a role, and can be referenced with the name. Furthermore, a consistent restriction (condition) item name can be added, and the role model that can be also referenced by indexing the item name. Also the role itself has a hierarchical structure, and can be referenced in a successive manner.

The concept of a role represents the contents of fact to be executed by an individual party, and is associated with the environment surrounding the party. Accordingly, the contents to be executed vary according to a change in the environment. Namely, the structure of an object network, etc. must be adaptively changed according to an environment.

For this implementation, a consistent restriction (condition) item is used. Contents of a consistent restriction item are written as the contents of a cell within a template that is defined as a data model corresponding to a noun object and a verb object within the object network. As shown in FIG. 30, the contents are defined within the object network as an attribute item associated with a data definition preparation operation for a noun object, and with a verb service execution preparation operation for a verb object, and processed by a party, for example, a user with a driving method corresponding to the operation name.

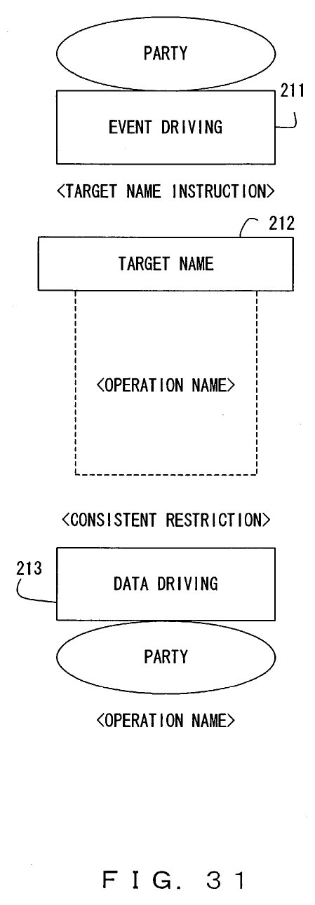

FIG. 31 explains the relationship between a party associated with such a consistent restriction, and a driving system. In this figure, the party instructs, for example, the name of a noun object as a target name, and instructs a WELL system to execute the noun object as event driving 211. The WELL kernel verifies a consistent restriction condition by performing an operation having an operation name which is associated with an item written in the template corresponding to the object having the instructed target name 212, and the WELL system instructs the party which performs an operation with data driving 213 to perform an operation having the operation name via the common platform according to a result of the verification.

For example, a consistent restriction item that is defined by an expert and embedded into an object is associated with a consistent restriction item of another object resultant from the process of a support role capability which provides a recognition action service for a restriction characteristic item of environment data, for example, with the communication capability service as explained with reference to FIG. 22, and used for a linkage operation with an object network to be executed next.

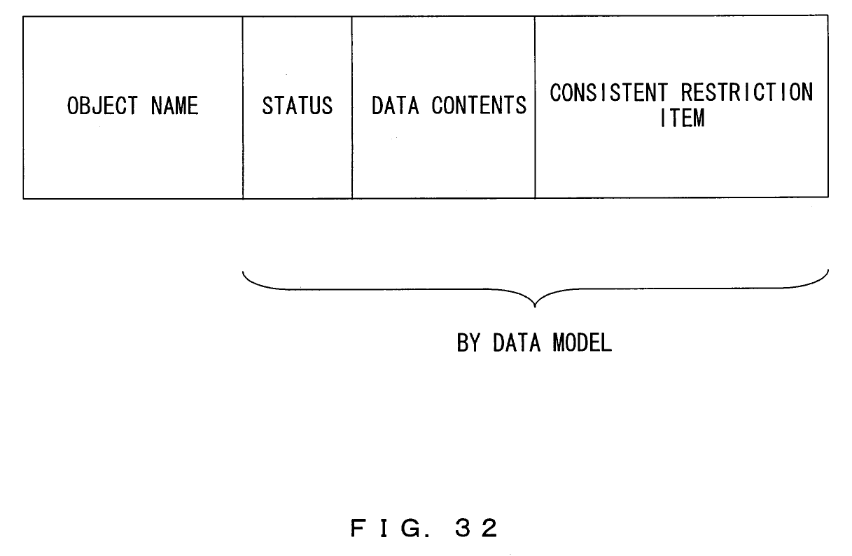

An object network is defined by a graph structure composed of a noun object as a node, and a verb object as a branch as described above. FIG. 32 explains the template of an object. As cell contents of the template, four items such as an object name, status, data contents, and a consistent restriction (condition) item are defined. For a generic object, its name is possessed as a parameter for concretization as data contents, so that a link of the hierarchical structure of objects is formed. Additionally, a hierarchical parameter is successively concretized with a consistent restriction item.

Fundamental data contents of a noun object include a numeric value, a symbol, etc. as specific primitive data, an abstract name, an object name as the above described parameter for concretization, and the like.

The most specific content as the data contents of a verb object is a function name. As a matter of course, the function name must be a name that can be referenced as an executable algorithm.

Also for a function, a conversion process from an abstract function to a specific function exists likewise the contents of a noun object, and its structure is put into data. This structure is generally implemented so that its conversion can be made by a specific role server via an agent role server, or put into data so that an execution request can be made with event driving.

To plan and devise a process, execution of a process performed by a plurality of role capabilities is planned in correspondence with a consistent restriction item defined in a verb object within the plurality of role capabilities. A control according to a temporal restriction such as a continuation process, a synchronization process, a suspension process, a resume process, etc. is performed as the control form at this time.

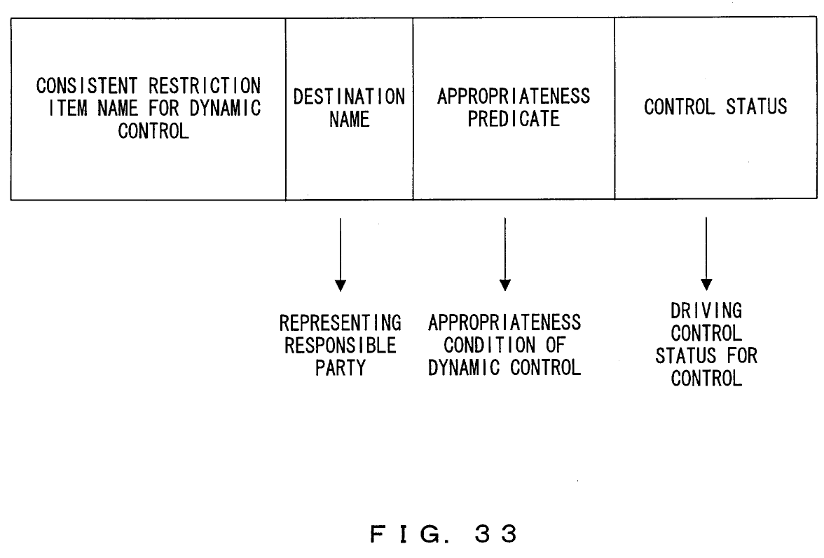

FIG. 33 shows the contents of a template for dynamically controlling a verb object as described above, and also shows the details of the cell contents of the consistent restriction item shown in FIG. 32. In this figure, a destination name indicates a responsible party. An appropriateness predicate pairs with a noun object as a subject, and indicates an appropriateness condition for a dynamic control of a dynamically selected verb object. Control status is intended to control the feasibility of a service of the party in correspondence with the current status of the party in response to a process request issued to the party.

The process for representing an intention is further described next. FIG. 34 explains the definition structure of an intention. As the first stage, a target area name, and an attribute structure of the target area are defined. In the above described example of the two automobiles, two-way traffic is the target area, and the attribute structure of the target area is data indicating whether or not a road is a priority road, whether the road is either one lane or two lanes, and the like.

In the first stage, appropriateness checking is made for the attribute data of the target area of a party with an interaction with the system by determining whether or not the party is qualified for realizing an intention about the target area. For example, if the party achieves an intention to perform a steering operation of an automobile on a certain road, having a qualification for performing a safety steering operation is one of access rights for a road condition. This can be considered as an access right in a social system, which allows a plurality of drivers to make an accident-free drive.

Furthermore, to make an Internet communication, a party must have a legal terminal and a communication path, and a specific access is allowed with an interaction with a system by using data including an account, and a PIN such as a password, etc. for obtaining authentication for qualification.

Namely, a party plans the execution of an intention about a target area, and issues a <target name instruction> with event driving 211 as shown in FIG. 31, so that the system starts the process for an object network corresponding to an <operation name>. At this time, verification is made for a <consistent restriction condition> added to the object corresponding to the <operation name>.

In the definition structure of an intention shown in FIG. 34, conversion from a generic intention, which corresponds to a generic object network, to a specific intention, which corresponds to a specific object network, is successively made subsequent to the definition of the target area. In that flow, a <data driving> operation is requested from the system to the party by determining the appropriateness of a condition written in a consistent restriction item added to a generic or a specific noun object, so that necessary data or a necessary operation is obtained.

Namely, as the second stage, whether the intention is independent, common, or contradictory as the nature structure of the intention, an operable structure of the intention, for example, an operable range of a brake or a steering wheel for preventing a collision, and a target (target function) of the intention such as collision prevention, etc. are defined in association with the intention. Additionally, in this stage, setting of a template for the operable structure, and the like are made as an intention definition preparation process for a support.

Then, specification of a partial recognition capability, etc. are decided to extract the characteristic structure, for example, whether or not there is a curve on a road, or the like, of environment data for the target as the definition of a support structure for achieving the intention.

Lastly, a strategy and a tactic are defined. The strategy is a generic restriction for an operation for achieving an intention. A restriction on an environment or a physical operation, an operation for achieving a target, and the like are defined in the strategy.

Then, the tactic is decided. The tactic is implemented by concretizing the generic nature of an operation as a strategy. Conversion from the generic nature to a specific nature is made, for example, by receiving a user operation instruction with data driving.

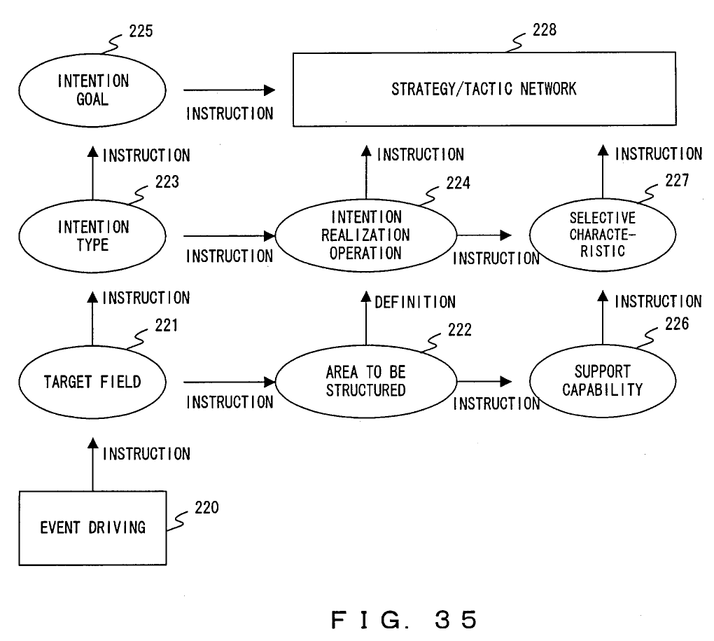

FIG. 35 shows the entire configuration of a generic object network for finally deciding a strategy and a tactic for realizing an intention. As explained with reference to FIG. 34, the target area of intention realization is a generic noun object. Therefore, an instruction of the target area that suits the intention in a list represented on a common platform is received from a client with <event driving> 220, and attempts are made to achieve the target intention in accordance with FIG. 35. At this time, concretization of generic items is successively made in the definition structure of the intention, such as the attribute structure of the target area, etc. as explained with reference to FIG. 34.

In FIG. 35, a start is made from the state where a party, for example, a client as a user does not have any intention initially. Then, the party issues an instruction of a target field of an interest of the party, namely, a target field 221. Since a specific target area is not defined at this time, a list of target areas that can be provided from the system is displayed on the common platform with data driving. Then, definition of the attribute structure of the target field 221 instructed by the user, namely, an area to be structured 222 is made. If two-way traffic is selected as the target field 221, for example, two automobiles are defined as the attribute of the area to be structured 222.

When the user specifies an intention type 223 on an operation window as event driving, an inquiry is made as data driving from the system side about whether the intention is an independent, a common, or a contradictory intention. Then, the user instructs any of the types. Here, for example, a common intention is selected.

Then, the above described operable ranges of an accelerator, a brake, a steering wheel, etc. are decided by the user as the contents of the operable structure of the intention, namely, as the contents of an intention realization operation 224 by supplementing undefined data within a template according to the intention type 223 and the area to be structured 222. Then, an intention to cooperatively prevent a collision is defined as an intention goal 225. The specific goal of the intention is represented as the passing of the two automobiles each other at the minimum allowable interval, and its contents are displayed on a message window as a message from the system.

To realize an intention, data of environment is also required as described above. Namely, a role that extracts a characteristic amount from environment data, and supports the decision of an operation amount is required. A support role capability suitable for a target area is selected as a support capability 226 by the user. For example, in the case of two-way traffic, a road map indicating the proceeding directions of automobiles with a GPS, a proceeding prediction system of the other automobile as a camera system, and the like are considered. For instance, a support role capability that represents an enlarged road map and proceeding data of the other automobile on a GPS screen by using vectors is selected, and the support structure for achieving the intention, and the specification of a recognition capability are defined. Furthermore, data of the proceeding characteristics of the two automobiles, which are undefined in a template structure, are assigned in correspondence with data driving made by a selective characteristic 227.

A controllable operation amount, to which restriction conditions are added, is defined by the intention realization operation 224, and the amount that a steering wheel can be turned according to the current proceeding speed of an automobile is added as one of the restrictions in the case of the two-way traffic. Then, a strategy and a tactic are decided by a strategy/tactic network 228 in correspondence with the data input from the intention goal 225, the intention realization operation 224, and the selective characteristic 227.

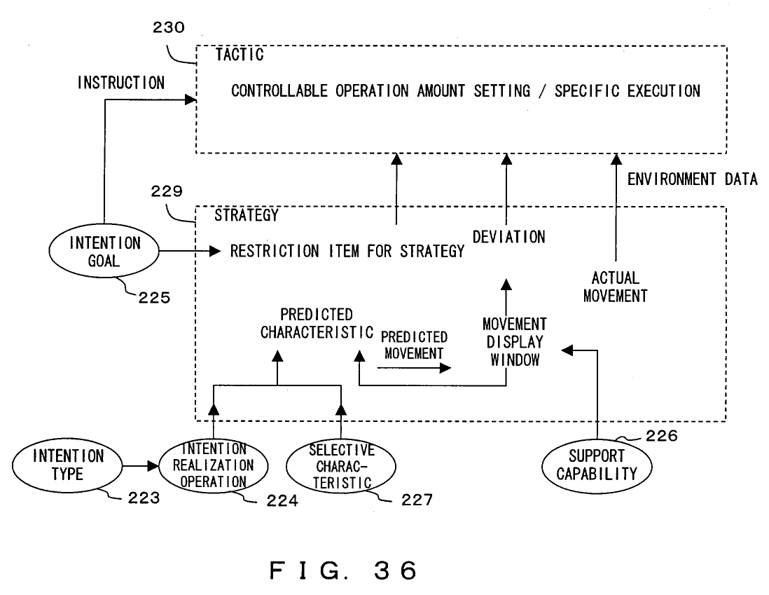

FIG. 36 explains a generic object network for a strategy/tactic. In this figure, restrictions on an environment and a physical operation, and regulation of priority are restriction items for a strategy 229, and the base of the strategy is to perform a smooth operation by reducing the restriction data so as to allow a party on the other side to easily predict the movement of this side while maintaining cooperativeness with the other party in an operation for achieving a goal.

In FIG. 36, movement data predicted based on an intention realization operation 224, a selective characteristic 227, etc. is compared with actual movement data on a data window which displays movements. Their difference (deviation) is combined with an intention goal 225, etc., and used to decide a tactic 230. The tactic 230 specifically decides a controllable operation amount by using the restriction item group stipulated by the strategy 229, environment data, and data such as the difference between the predicted and the actual movements, and also decides a specific execution process for realizing the intention.

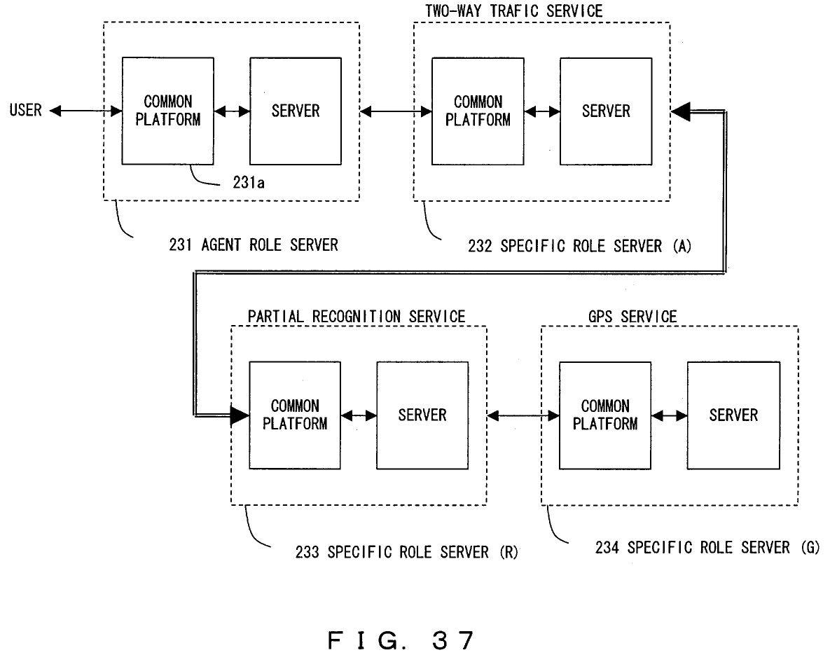

FIG. 37 explains a connection structure of servers for realizing an intention. In this figure, an agent role server 231, a specific role server (A) 232 which realizes a two-way traffic service, a specific role server (R) 233 which realizes a partial recognition service, and a specific role server (G) 234 which executes a GPS service are connected.

On a common platform 231a of the agent role server 231, a generic object network defined by an agent expert is displayed. This network is represented as a graph by using a generic noun object and a generic verb object. To convert this generic object network into a specific object network, parameters in changeable portions, which are represented as being generic, must be concretized, and a user is requested to specify the conversion from a generic name to a specific name as data driving. With this specification, for example, two-way traffic of two automobiles is selected as a target area.

The specific role server (A) 232 that can implement a two-way traffic service is selected from a database by the agent role server 231, and connected to the agent role server 231. Then, a template corresponding to operation amount data is set by the specific role server (A) 232 in correspondence with an operation instruction of the user from the intention type 223 shown in FIGS. 35 and 36 to the intention realization operation 224 also shown in FIGS. 35 and 36.

Similarly, if the support capability 226 shown in FIG. 35 is instructed on the common platform 231a of the agent role server 231, a selectable item list is displayed on the common platform 231a. If a GPS service is selected by the user, the GPS capability itself or a simulator is referenced, and the specific role server (R) 233 for a partial recognition service, to which the specific role server (G) 234 for a GPS service executing the GPS capability is connected, is connected to the specific role server (A) 232 for a two-way traffic service.

Then, with the specification of the selective characteristic 227 shown in FIGS. 35 and 36, the partial recognition capability for the specified characteristic restriction amount is implemented by the specific role server (R) 233. Namely, the necessity of the capability of the specific role server (R) 233 is specified by the specific role server (A) 232, and the specific role server (G) 234 is stipulated as a support role capability which satisfies the necessity. For example, a human being may be set as a suitable visual recognition capability.

As described above, a method with which an expert makes a decision, or a method of building up experience with a learning capability possessed by a user who executes an intention is adopted to concretize a generic strategy and tactic for an intention realization process. A method and a structure for achieving an intention are decided in a top-down manner in the former case, or in a bottom-up manner in the latter case.

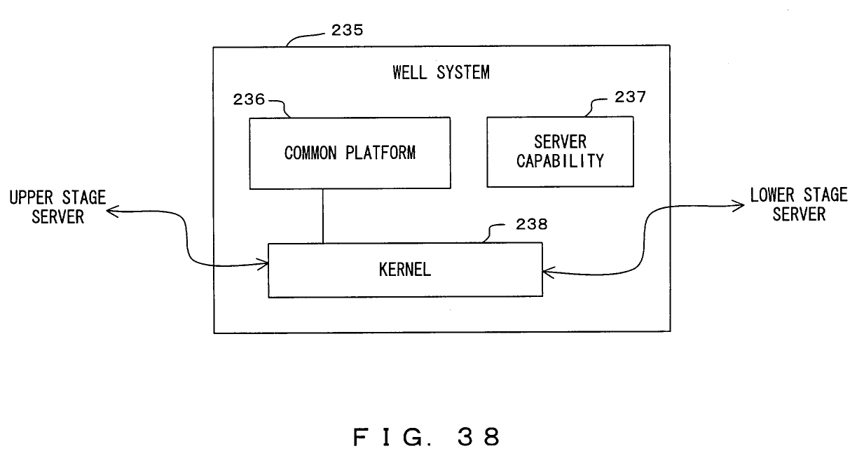

FIG. 38 is a block diagram showing the configuration of the agent role server 231, or the three specific role servers 232 to 234, which are shown in FIG. 37. Each of the servers is configured as a WELL system 235, and includes a common platform 236, a server capability 237, and a kernel 238. The kernel 238 controls communications with servers on both sides, which are connected to the local server. For example, the agent role server 231 controls a communication with a user, and a communication with the specific role server (A) 232. These communications are made only with data in the formats defined by the common platform 236. For example, the communication with the user is made by using the user-friendly data format, and the communication with the specific role server (A) 232 is made by using the data format suitable for a communication between the servers.

A network service system according to a preferred embodiment of the present invention is described in detail next. As described above, this network service system has fundamental characteristics such that a party, for example, as a client that request a service, and a party as a server that partially provides a service, or integrates partial services and provides the integrated service to the client, and the like respectively comprise an intention realization data processing device using a WELL system as a core, and overall external environment data as common data for providing/receiving a service can be referenced in a parallel manner when each of the parties requires the data.

Intention realization data processing devices respectively comprised by the parties correspond to nodes within a network, and the nodes fundamentally operate in parallel and independently. Within each of the nodes, various types of roles exist in parallel, and the roles reference the overall external environment data when they require the data.

Each of the intention realization data processing devices fundamentally performs object-oriented data processing, and an object is hierarchically configured by four models such as a data model, an object model, a role model, and a process model as stated earlier. Also the models operate independently and in parallel. A parallel operation is also performed, for example, within a node of a client, and also an operation between a client and a server, namely, an operation via the overall external environment data is performed in parallel. This operation uses the overall external environment data as common data. A shared memory storing this data may be arranged in one location within a network, or in a plurality of locations within the network by storing copied data.

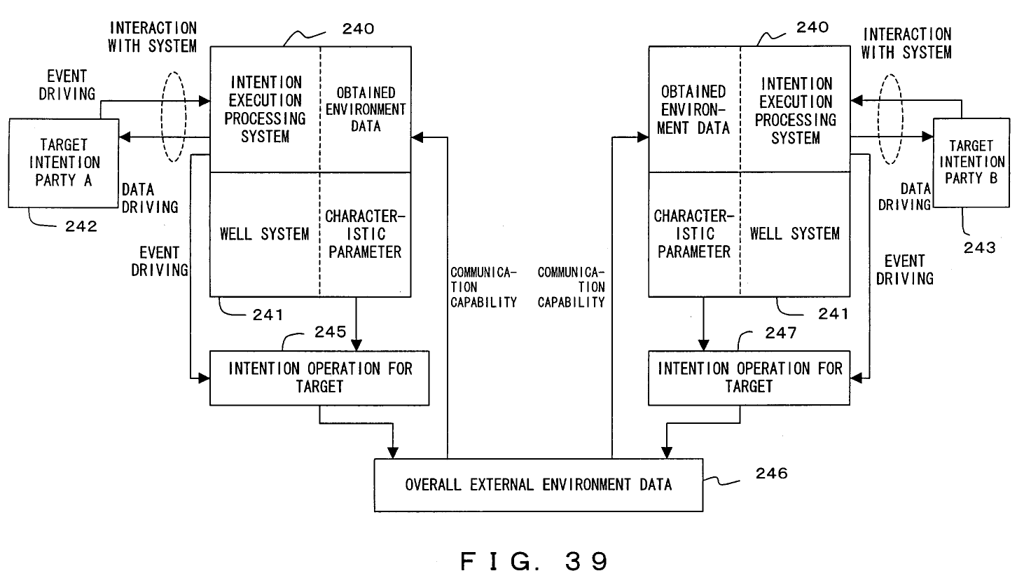

FIG. 39 explains a bidirectional interaction capability in a network service system. In this figure, a bidirectional interaction capability is implemented between a plurality of parties A and B via overall external environment data.

In FIG. 39, for example, event driving for a target intention 242 is provided from the party A to an intention execution processing system 240, namely, an intention realization data processing device. The intention execution processing system 240 comprises a WELL system 241 as its core capability.

The intention execution processing system 240 makes an external operation device execute an intention operation for the target 245 as event driving in correspondence with the intention of the party A. As a result, this operation is reflected on overall external environment data 246. As will be described later, a result of the intention operation is accumulated as a characteristic parameter for each party in the overall external environment data 246.

A target intention 243 is also provided from the party B to an intention execution processing system 240, and a characteristic parameter is accumulated in the overall external environment data 246 with an intention operation 247 for the target in a similar manner as in the case of the party A.

When the intention execution processing system 240 makes the external operation device execute the intention operation for the target 245 with the event driving in correspondence with the intention of the party, it references the contents of the overall external environment data 246 by using a communication capability, determines data consistency by using the contents as obtained environment data, and maintains processing consistency as the system.

If the parties A and B have a common intention in FIG. 39, a cooperative operation between the parties is performed to realize the common intention. Or, if the parties have contradictory intentions, they use the WELL system in order to recognize mutual operations. A role capability that extracts necessary environment data with a support capability from the data respectively possessed by the parties, and the data displayed on the common platform, which is intended to display overall external environment data, is used as explained with reference to FIGS. 27 to 29. As a result, the cooperative or the contradictory relationship is processed.

In FIG. 39, for example, media information is handled in the WELL system, and an interaction is made between the parties with a bidirectional interaction capability. In this interaction process, the intention execution processing system 240 comprising a generic object network for realizing an intention, which is described with reference to FIG. 35, serves as a core capability. The base of the interaction capability is an interaction made between the two parties A and B. If a mutual association exists among the intentions of a large number of parties in an interaction made among the large number of parties, each of the parties consistently achieves a common intention or a contradictory intention in the intention goal 225 shown in FIG. 35.

If a plurality of parties are dynamically formed as a team, and consistent processing for common, independent, and contradictory intentions of the parties must be performed within the team, it is important that a team leader or manager verifies the consistency of the intentions of the parties within the team as an agent so as to maintain the consistency.

The overall external environment data 246 shown in FIG. 39 includes structure data of the parties A and B associated with the system, and the attribute structures of target areas associated with intentions as its data. The overall external environment data 246 also includes data of restriction condition items for the respective parties as data that the parties themselves can recognize in correspondence with an action of a party, namely, an intention operation for a target.

In FIG. 39, the target intention of the party A or B is reflected on the contents of an operation such as a strategy or a tactic for an action to be taken by the party itself for the target area of the intention whose definition structure is described with reference to FIG. 34. When the intention operation for the target is performed in correspondence with the target intention, the overall external environment data 246 is referenced to obtain the characteristic data of external environment data by using a support capability, namely, a communication capability, and an interaction operation is started as an interaction between the party and the system.

To perform such an interaction operation, the party uses a suitable terminal capability. The capability of the terminal in a WELL system is to issue an instruction with event driving on the window explained with reference to FIG. 7, namely, the window which displays a strategy/tactic, etc. for achieving an intention as a generic object network, to successively concretize the generic object network, to maintain consistency with overall external environment data, and to realize an intention. When a change occurs in the overall external environment data 246 due to the intention execution operation of a party on the other side in this case, an operation is performed dependently on the object network on the display, and on the change in the data, and the necessity to adapt to the environment occurs.

For the above described reason, the operation for making an interaction with the system is performed by using an object network with which a party instructs the specific target of an intention, and, for example, a portable terminal for a remote control. The object network and the portable terminal must be made operable by being associated with each other for the sake of convenience.

In the intention execution process, for example, an interaction process with the system is performed successively and hierarchically so as to achieve the goal of an intention of each party based on an independent intention. Namely, a successive concretization process from a generic object network to a specific object network is executed as an interaction process in correspondence with a hierarchical object structure composed of a data model, an object model, a role model, and a process model.

That is, an adaptation operation for achieving the intention of each party is performed in correspondence with an intention sequence, namely, a time sequence of a unit intention as a simple intention, which is generated by each party with an interaction with the system by using the bidirectional interaction capability shown in FIG. 39. The adaptation operation is performed by referencing an overall external environment including the other party, namely, the overall external environment data 246, and by concretizing a strategy/tactic within a generic object network of an intention. The consistent restriction for dynamically controlling a verb object, which is described with reference to FIG. 33, is used to change the dynamic process for achieving an intention goal.

The simplest interaction method corresponding to FIG. 39 is, for example, the case where a user as a client is one party, a server which provides a service to the user is the other party, a WELL system is comprised in intention realization data processing devices of both of the parties, and an interaction is made between the parties. Assuming that media information is provided to the user as a service at this time, multimedia contents, which mainly include a moving picture, become an intention target.

For the intention of an associated party, the attribute structure of an intention, which is described with reference to FIG. 34, is defined, and concretization from a generic level to a specific level is made. Firstly, the name and the attribute structure of a target area of the intention of the associated party are specified. For example, if road traffic is the target area as described above, a target object as a party that moves on a road must be defined as the attribute structure of the target area. As a result, the area to be structured 222 described with reference to FIG. 35 is concretized. By way of example, for multimedia contents, a stage and a character are concretized.

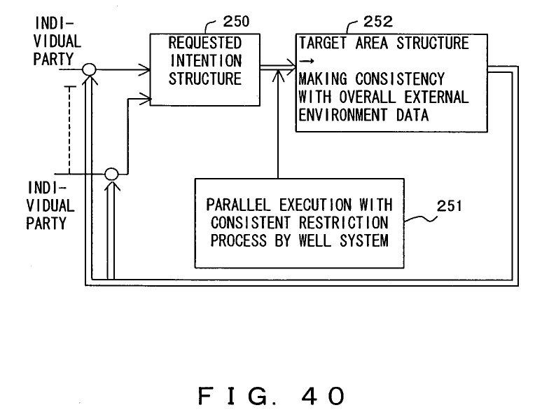

FIG. 40 explains a parallel definition process for an intention, which is performed by an associated party. In this parallel definition process, the definition of a target area structure must be made by making consistency with the overall external environment data 246 shown in FIG. 39 in correspondence with the structure of an overall intention including the intentions of individual parties.

Namely, in FIG. 40, the individual parties input requests which respectively correspond to their intentions, and a WELL system makes parallel execution 251 with a consistent restriction process for a requested intention structure 250 into which the requests are integrated, so that a process for structuring the requested intention structure 250 as a target area structure is executed. Furthermore, making consistency 252 makes consistency between the overall external environment data 246 and the target area structure in the WELL system, and its result is fed back to the individual parties.

In such a parallel definition process, the respective parties activate their intentions with the event driving 220 for the generic object network shown in FIG. 35. At this time, the overall external environment data 246 for the target area is recognized by a communication capability as a support capability possessed by each party, and the selective characteristic 227 is extracted. Then, the intention operation for a target 245, which is shown in FIG. 39, is performed as an external operation for the strategy/tactic network 228 in correspondence with the extracted characteristic and an instruction of the intention realization operation 224.

A result of such an intention operation for the target emerges as a change in the overall external environment data 246. This change is received by each party as data of a supported structured area associated with the intention of each party via the support capability 226, namely, the communication capability possessed by each party. In this way, the result of the operation activated by the intentions of the respective parties is represented as the overall external environment data 246, and an associated party can receive the selective characteristic 227 shown in FIG. 35 by referencing the data.

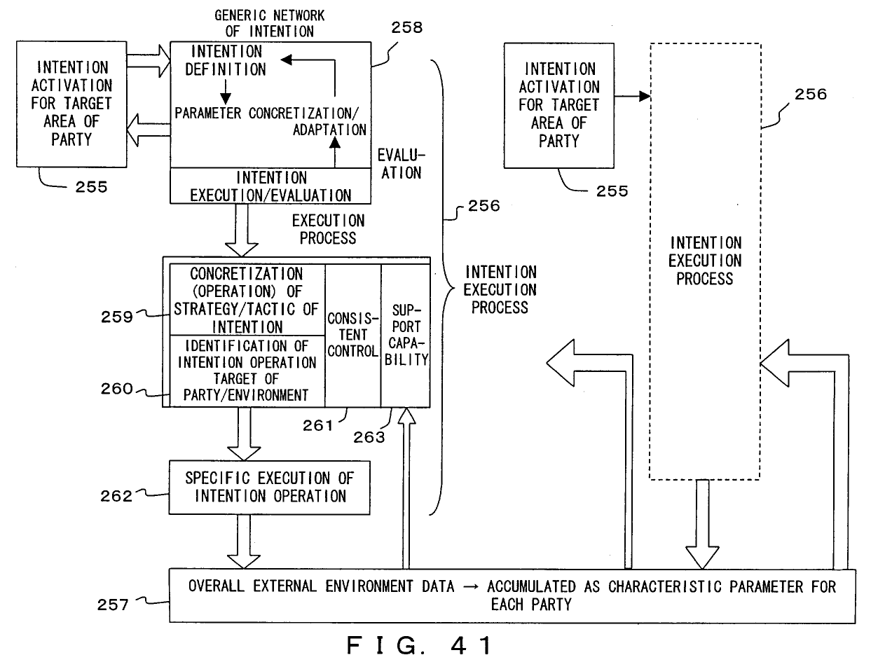

FIG. 41 explains such an execution process of the intention of each party. Firstly, each party issues an instruction to a generic network of an intention 258 as intention activation for a target area 255. In response to this instruction, parameters are concretized in the generic network of an intention 258, and intention execution is instructed to an execution process.

In the execution process, concretization of an intention strategy/tactic 259, and identification of an intention operation target party/environment 260 are performed in correspondence with characteristic parameters for the target area, especially, characteristic data of an intention such as an independent, cooperative, and contradictory intention in terms of the other party. In correspondence with the concretization and the identification, specific execution of an intention operation 262 is made. At this time, consistent control 261 is performed within the execution process.

The result of the intention operation is accumulated as a characteristic parameter for each party in overall external environment data 257, and the data is provided by a support capability 263 to the generic network of an intention 258 as an evaluation of the intention operation. The party that activates the intention determines the evaluation as an effect provided to the other party, namely, a sensitive effect provided to the other party, and by changing the strategy/tactic adaptively, a significant influence is exerted on the flow of the interaction process.

Namely, the overall external environment data 257 extracted by the support capability 263 exerts an influence on the definition of an intention, as an adaptation of a parameter, etc. in the generic network of an intention 258. Its evaluation result also exerts an influence on the strategy/tactic of the intention in the execution process. Then, the specific execution of an intention operation 262 as an operation result of the strategy/tactic network exerts an influence on the overall external environment data 257.

In FIG. 41, the plurality of parties of the system, namely, the associated parties make the intention activation for a target area 255 and an execution process of an intention 256 in parallel. As a result, the respective parties evaluate their intention operations based on characteristic parameters within the overall external environment data 257 including the other party, and reflect the evaluations on the structure and the operation of the strategy/tactic network corresponding to the next intention operation.

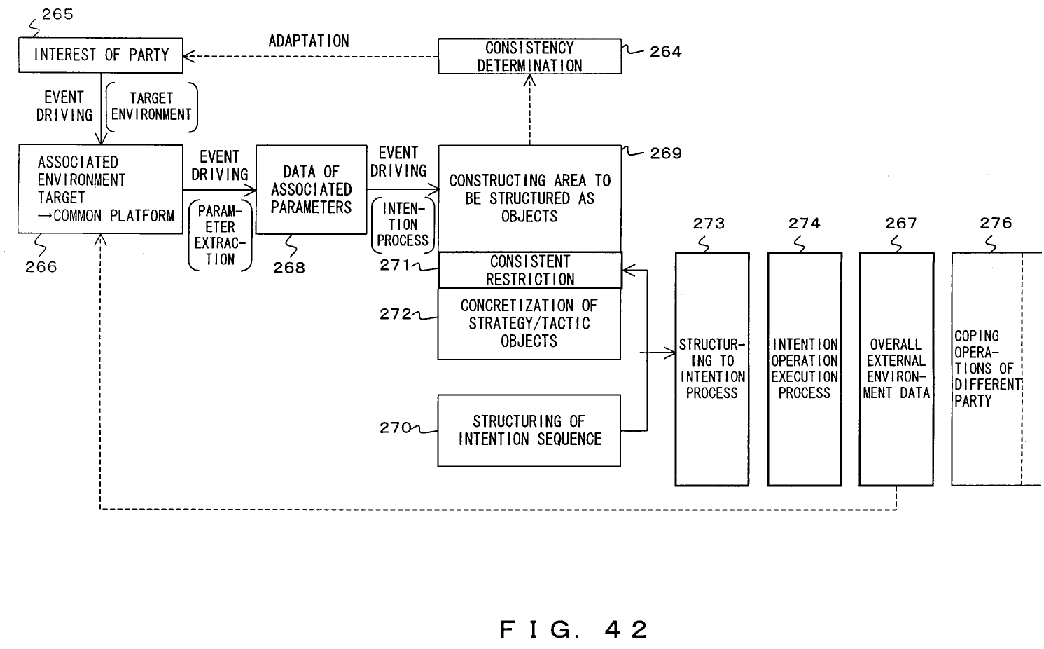

FIG. 42 explains the flow of the intention execution process, which is performed with event driving, for each party. In this figure, if a target environment is instructed to a WELL system as event driving in correspondence with an interest of a party 265, data corresponding to an associated environment target 266 is extracted from overall external environment data 267, and displayed on a common platform. Then, an interest parameter is extracted by the party as event driving, and associated parameter data 268 is provided to the intention execution processing system, namely, the WELL system as event driving.

In the WELL system, construction of an area to be structured 269 as objects is made in correspondence with this event driving, and concretization of strategy/tactic objects 272 is made with a consistent restriction 271 on structuring to an intention sequence 270, namely, structuring to a unit intention sequence. Then, structuring of an intention process 273, namely, an intention sequence such as a soccer game process to be described later, etc. is made, and an intention operation execution process 274 is executed. Its result is reflected on the overall external environment data 267.

A result of the process with the consistent restriction 271, etc. performed by the intention execution processing system causes an adaptation made to the interest of the party 265 according to the process of consistency determination 264. Namely, an adaptation of the unit intention as the interest of the party, that is, a change in the interest can possibly occur as the intention execution process proceeds. Additionally, response of a different party 257 represents exactly the same as the left side of the overall external environment data 267, which indicates that the intention execution process is similarly executed also for the different party with event driving.

In the intention execution process described with reference to FIG. 42, the execution process is verified by using the consistent restriction condition items that correspond to noun and verb objects which are described with reference to FIGS. 30 and 31. In FIG. 30, the statuses of a noun object 204 and a verb object 207 indicate the statuses of the objects to be executed by the process shown in FIG. 42, and are associated with data control for the consistent restriction conditions.

To perform an interaction process, which corresponds to, for example, a cooperative or a contradictory intention, among parties in a network structure where nodes corresponding to respective parties are connected, hardware for an interface, which provides a necessary service capability, becomes necessary. That is, to make an interaction required for a service which is provided/received on the network, system configuration for implementing the service capability for that interaction is set.

Furthermore, to perform a cooperative intention realization process between the intention of a party as a client that requests a service, and a server as a party that provides the service, the structure of an environment, a model driving capability for the service capability, and an interaction capability on the network must be defined as the first, the second, and the third requirements.

In the first place, characteristic data of an associated target of an associated party is defined as the definition of the structure of an environment. Then, overall external environment data composed of a set of these data, and data required for the execution process of an intention, which is executed between the parties, are provided/received by a communication capability. For the overall external environment data, 1) an ID of an individual target, 2) a synchronous identification mark for the operation status of the individual target, 3) a partial display mark of the individual target, 4) a search mark within the individual target, 5) an identification mark of a service capability of the individual target, 6) a browser operation mark of a service capability, 7) a status display of a device for a service, and the like for the target area are defined as structured data, and the service is provided by both of hardware and software capabilities.

The overall external environment data into which data of a plurality of associated parties are integrated is intended to represent the external data of an intention operation of a party with a characteristic nature, and consistent restriction item data associated with the nature. The overall external environment data is provided as a result of the execution process to each party by a service capability according to an individual intention.

The process for obtaining such overall external environment data is explained with reference to FIG. 27 in association with data driving, FIG. 28 in association with event driving, and FIG. 29 in association with the cooperative process of a partial recognition capability. Connections within the network which are intended to obtain data by dividing the responsibility for a service, etc. are described with reference to FIGS. 37 and 38.

In the second place, a model driving capability for the service capability becomes necessary. To execute an intention process for a service which is provided/received by the network service system, a support capability based on the target area and the definition of an intention must be implemented, as a precondition.

This support capability extracts a characteristic from the environment data of a service target. The party as the server that plans and executes the service mainly decides the attribute structure of a target field, and the side of the party as the client that receives the service controls the process execution as an intention operation.

The attribute structure is defined in correspondence with models such as data, object, role, and process models, which are adopted by the WELL system. The base of the attribute structure is the data model, and a cooperative or a contradictory operation is performed via a role in charge of each party in a hierarchical order of the object and the role models.

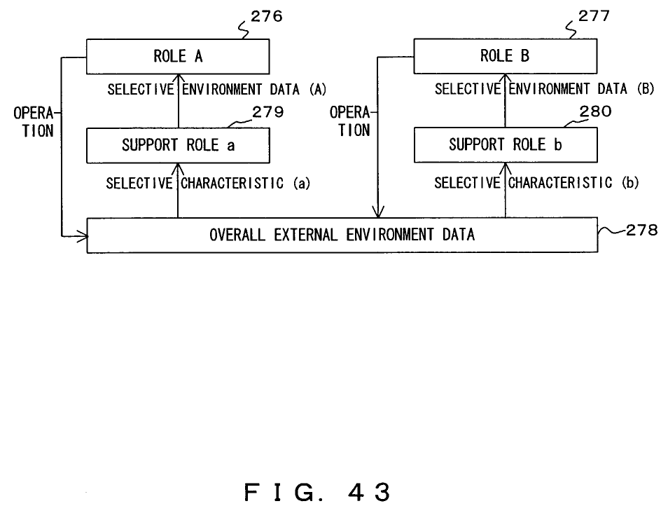

FIG. 43 explains the execution of a process with mutual actions of role capabilities. For example, role capabilities of roles A276 and B 277, which respectively correspond to parties A and B, perform an operation for overall external environment data 278 in parallel. Then, selected characteristics corresponding to the roles A and B are extracted by support roles a 279 and b 280, and the extracted data are respectively transmitted to the role capabilities as selective environment data. Operations of a strategy/tactic object network are performed based on mutual monitoring in correspondence with a goal set to configure a cooperative or a contradictory intention in this flow, so that the process execution proceeds.

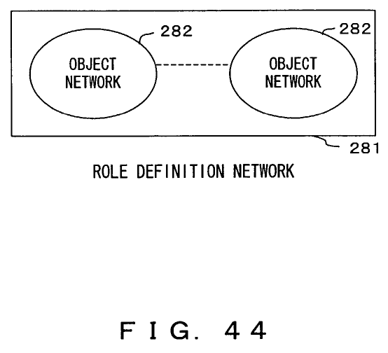

FIG. 44 shows the configuration of a role definition network 281 corresponding to each role. The role definition network 281 corresponding to a role model is configured by a plurality of object networks 282.

In the third place, definition of the interaction capability on a network is explained by taking as an example the case where a team is configured in a service network system. A manager or a coach, and a plurality of team members (team parties), who configure the team, organically configure a service as a network service system based on an interaction with the system as a server or a client. To implement this, a service menu is defined as a service category in the network.

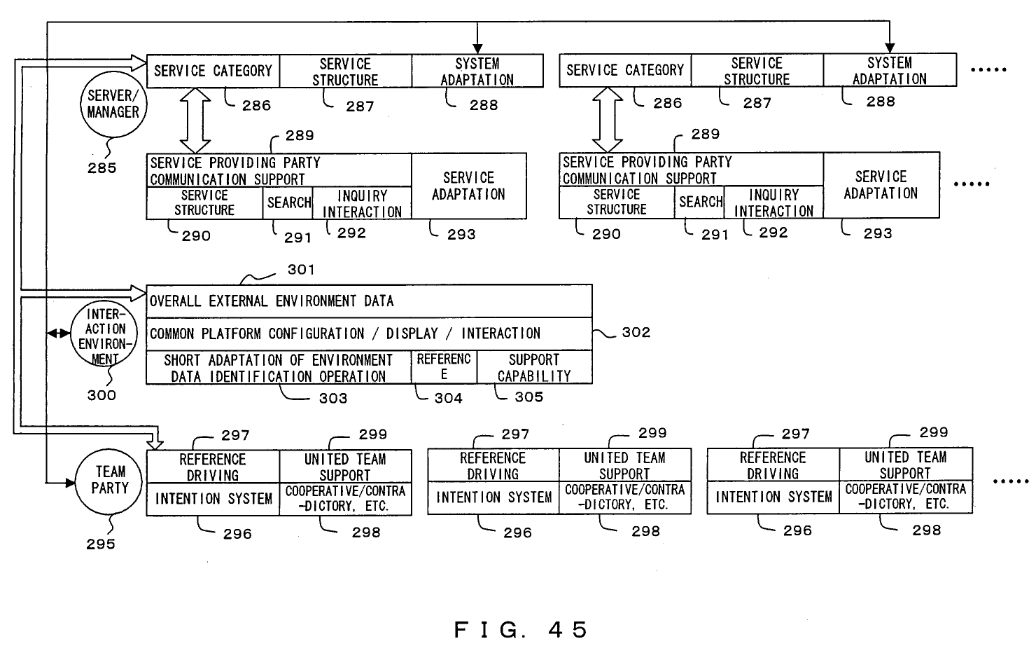

FIG. 45 shows the service execution environment of the network as component configuration of objects. In this figure, objects such as a service category 286, etc. are respectively defined in correspondence with the manager or the coach, namely, a party 285 corresponding to a server. Additionally, an intention system 296, etc. are comprised in correspondence with each of team parties 295, and overall external environment data 301, etc. are comprised as an interaction environment 300 between the server/manager 285 and the team parties 295.

The service category 286 is put into hierarchies according to the hierarchical levels of role capabilities. In the first place, a generic service is managed for the party such as the manager or the coach, etc. as an agent capability (server), and a service for successively converting a generic service into a specific service is executed by a service system under the management of the agent capability. A service structure 287, which corresponds to the service category 286, comprises an intention system, and system adaptation 288 is made according to the course of the execution process of an intention. Additionally, a support system which satisfies the intention of the client is comprised to execute the service category 286 and to make the system adaptation 288. The capability of a service providing party communication support 289, etc. in this support system play an important role for the above described execution of the service category 286, and system adaptation 288.

In the second place, each of the team parties 295 responsible for a specific service receives a request to execute a divided service in correspondence with the service category set by the agent, namely, the server 285, and also receives an instruction for the flow of the execution process of the manager as the agent. Also the agent, namely, the server 285 is a client for the WELL system as a role corresponding to the service category. A difference exists only in a point that the server uses generic parameters, whereas a team party 295 as a client uses specific parameters.

Fundamental items of a design of the service execution process using a network shown in FIG. 45 are described next. The fundamental items include 1) the service category 286 and the service structure 287, 2) the service providing party, namely, the manager 285, and the team parties 295, 3) the service structure contents 290 and its search 291, and an inquiry interaction 292 about the operations of the team parties, etc., 4) common platform configuration/data display/interaction 302, 5) a selection of a synchronization operation between the service contents and the service category, 7) the overall external environment 301 and hardware/software architecture structure, 8) the support capability 305 for identifying and verifying environment data, 9) a short adaptation capability 303 of a service operation such as an environment data identification operation, etc., and short identification of a service name, for example, by using the syntax analysis of a service name, which will be described later, 10) a support capability of adaptation to reference driving 297 of a service process definition, 11) the intention system 296 for the team parties 295, and the like.

Here, the reference driving is described. The reference driving is defined as a process form, which corresponds to a reference model to be described later, based on event driving and data driving. The reference driving requests the system, for example, of the service to be executed by the reference model with event driving. Generally, an object network name, a role capability name, a process name, etc. are respectively a structure in the form of a generic or a specific object network. Namely, the reference model is intended to define a fundamental driving method for an arbitrary structure.

The reference model has an independently orthogonal relationship with the hierarchical object structure configured by a data model, an object model, a role model, and a process model, and is intended to implement fundamental services of the system in association with event driving and data driving.

The fundamental services include a structure service such as event driving, data driving, etc., a control process service such as a consistent restriction determination process, etc., a data structure service such as object name management, data management, etc., a communication service such as a communication between parties, etc., and a simulation service such as parameter evaluation, etc.

For a design of the above described service capabilities using a network, its base is that data required according to an individual request of each party is identified based on each support capability from overall external environment data integrated based on a data model, and made available by each party. As the entire system, the intention of a party as a client is notified to a party as a server, and an execution process proceeds based on data driving and event driving, and a WELL system on the server side notifies the client of, for example, requested data.

Here, the relationship between FIGS. 42 and 45 is further described. FIG. 42 explains the operations to be performed by all of parties in the network service system, and indicates that the target area of an intention is successively structured with event driving, and constructed as objects in correspondence with the interest of a party in the WELL system. During the course of this process, the target area interested by the party is converted into an area to be structured by being provided with a specific parameter.

Namely, the target field is constructed as objects with operations such as an event driving operation by using associated parameters provided from the party.

Furthermore, a unit intention is converted into an intention sequence, and an intention process is integrated and structured according to a consistent restriction. Furthermore, consistency is determined based on a consistent restriction in correspondence with the result of the structuring. As a result, an intention operation execution process is performed, and a result of the process is collected as data, and aggregated as overall external environment data. At this time, also data corresponding to other parties are aggregated as the overall external environment data.

The data thus aggregated is displayed on the common platform of each party, and an adaptation of the interest of the party is made by determining consistency, as a relationship with the other parties.

The flow of FIG. 42 is considered as a basic system with which the party as the server (manager) executes a service in correspondence with the service category shown in FIG. 45, and is a basic structure which provides software flow, which becomes the base. If the interest of a party, and a role defined in correspondence with the interest are changed, this flow is available as the basic structure unchanged.

In FIG. 45, the server that plays the role of the manager, and the members (team members) that configure the team exist as a party group, and mutual external environment data is configured by data instructed by the manager, and environment condition data of the team members, so that a cooperative operation is performed.

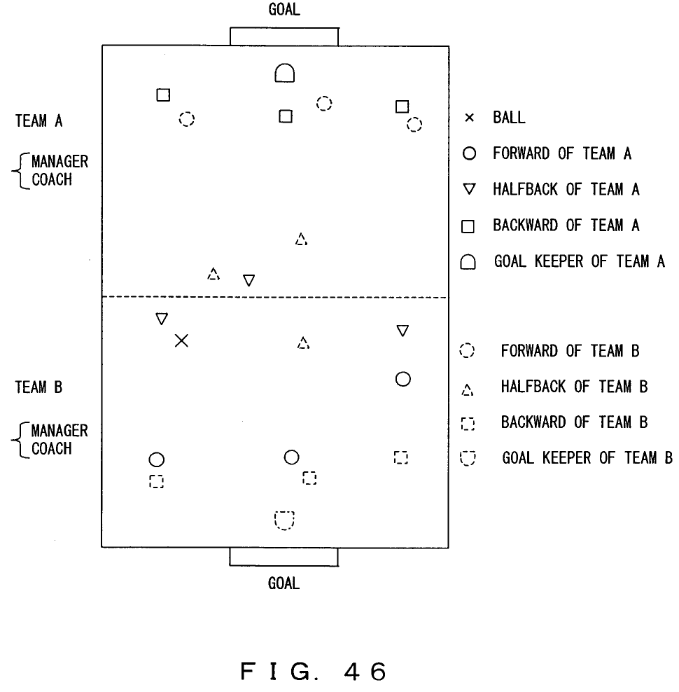

The service execution process in the network, which is described with reference to FIG. 45, is explained by taking a soccer game shown in FIG. 46 as an example. In FIG. 46, party groups of a manager, a coach, forward, halfback, backward and a goal keeper exist respectively for teams A and B, and the team members perform a cooperative operation to make a goal within each of the teams based on a strategy/tactic adopted by the manager, and an instruction given by the responsible coach according to the position of the goal, and the lineup of the opponent team.

By way example, for the individual parties of the team A, data of a dynamic position relative to a party of the opponent team B, the position of the goal, and the movement of a ball configure overall external environment data. Each of the parties recognizes the dress, etc. of an associated party as a characteristic for identification in order to instantaneously capture the movement of the associated party, as the short adaptation 303 of an environment data identification operation, which is shown in FIG. 45.

A team member as a party does not recognize the entire overall external environment data, but selects selective environment data, which is directly associated with the party, as described with reference to FIG. 43, and obtains important data according to the role of the party.

The coach and the manager prearrange a method, which executes an instruction to each of the team members as a service, with the team members, and define the service category or the service structure, that is, an instruction means and its contents for making the team members move like the arms and legs of the coach or the manager himself according to the movement of a body and the new position of the ball. Then, an adaptation as a service such that the instruction to the team members is not noticed by the opponent team side according to continually varying status is made for the communication capability for the instruction means and the contents.

For the team members, the reference driving 297 shown in FIG. 45, namely, training for learning ease of use for making the relationship between an instruction and a movement smooth by practice, and for making the adaptation of an intention system by which a goal is pursued as the entire team is important, and this is associated with the service structure and the system adaptation.

In the first place, to achieve the goal shooting of a ball as described above, it is important that movements for the generalization of the system and the flow of its concretization are smoothly conveyed within an own side team, and difficult to be noticed by an opponent team, that is, ease of use of the reference driving 297 is fully penetrated.

As described above, to provide/receive a service in a network as a network service system, a user first performs a specific operation corresponding to a requested intention by using a terminal capability. Accordingly, for example, transportation, media, multimedia contents such as performance, etc., or energy occurs as a result of this operation, so that the network service system becomes an overall control system on a global scale.

In the second place, data required by a network which is configured by a set of a node having such a terminal capability, and by a node having a generic or specific service capability is provided by a support of a media communication. Then, hardware and software as the entire network are designed, whereby the system is implemented. To make this implementation process efficient, a WELL system as a software architecture, which can cope with a service in every field, is effective.

In the third place, it is important that visibility is implemented in the entire structure of the network. Namely, it is necessary that a large-scale network system is implemented, contents of the network are arbitrarily searched to maintain sufficient security, and overall external environment data is allowed to be referenced by all of nodes.

In the fourth place, to implement the network as a form easy to use, it is important that the system structure for organically implementing all of services as a network is designed, and an intention realization data processing device which can implement such a system is made available.

As described above, a service capability provided by the network service system must be made complex, and must provide diverse services in many nodes. Accordingly, unless a service name is structured, and a capability of analyzing the syntax and the meaning of a name is comprised, the number of service names becomes very large, which requires a lot of time to make an analysis.

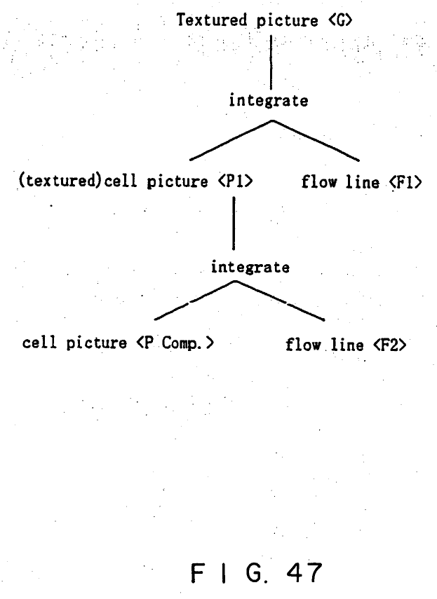

FIG. 47 exemplifies the syntax analysis of the name of a service which generates a textured picture. With such a syntax analysis capability, it is necessary to implement an ability to generate a corresponding service category according to the status of a network, etc., and a service structure for the service category, within the network as the attribute structure of the service.

When a service corresponding to a certain service category is provided as a network, it is important to secure its security by using a consistent restriction item added as an attribute, for example, to a noun object indicating a noun, for instance, in the communication capability explained with reference to FIG. 39, namely in a communication service.

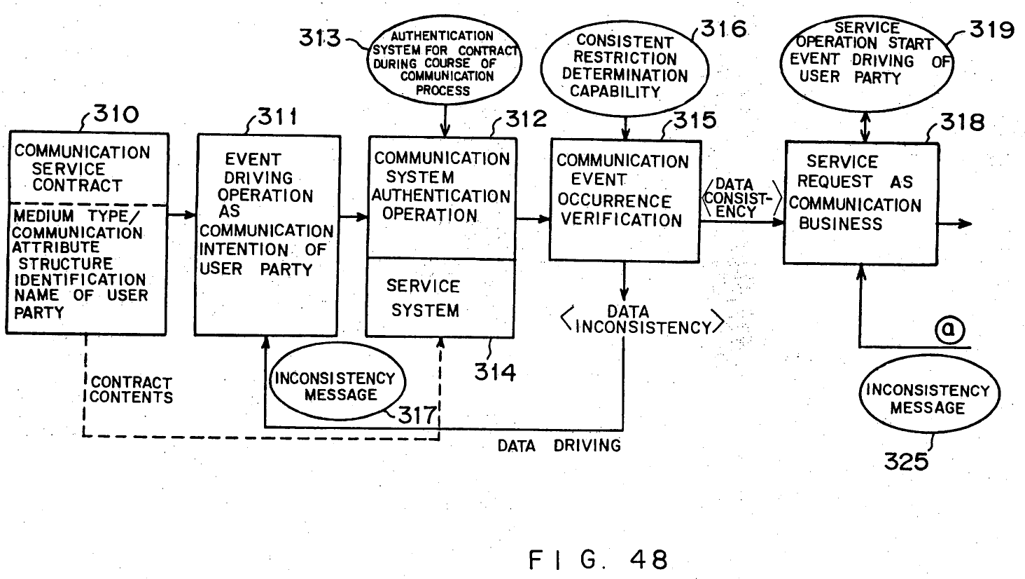

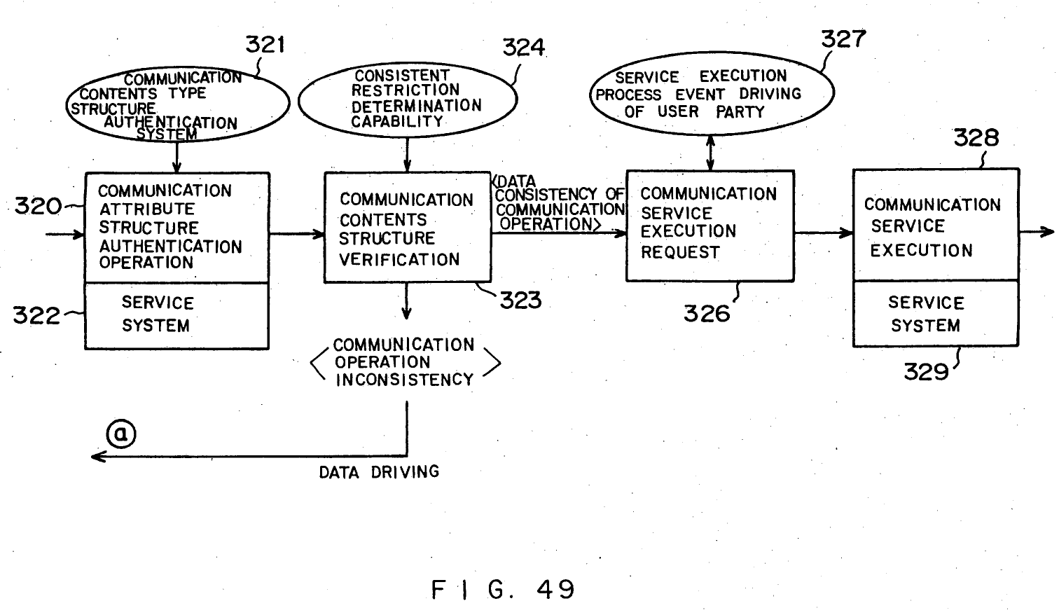

FIGS. 48 and 49 explain such a security securing method in a communication service.

In FIG. 48, a communication service contract 310 is made by using a medium type such as a telephone line type, a PHS, etc., a communication attribute structure, the identification name of a user party, etc. When an event driving operation 311 as a communication intention of the user party is performed, a communication system authentication operation 312 is performed. This authentication operation is performed by an authentication system 313 for a contract during the course of a communication process. Contents of the communication service contract 310 are used by a service system 314 depending on need, and a support for the authentication operation is made.

Then, data consistency is determined for communication event occurrence verification 315 by a consistent restriction determination capability 316. If <data inconsistency> is detected, an inconsistency message 317 is transmitted as a response to the event driving operation 311 as the communication intention of the user party. If <data consistency> is verified, a service request 318 as communication business is made in correspondence with service operation start event driving 319 of the user party.

FIG. 49 explains a communication service execution process succeeding the service request 318 as the communication business shown in FIG. 48. In this figure, a communication attribute structure authentication operation 320 is performed in response to the service request 318 as the communication business. This authentication operation is performed by a communication contents type structure authentication system 321. The authentication operation is performed also by being supported by a service system 322 if necessary.

Then, communication contents structure verification 323 is made. This is a process for verifying, by way of example, if entire communication contents are uppercase letters. This verification is made by a consistent restriction determination capability 324. If <communication operation inconsistency> is detected, an inconsistency message 325 is transmitted with data driving as a response to the service request 318 as the communication business shown in FIG. 48. This inconsistency message is a message that indicates the inconsistency of the communication contents structure.

When <communication operation consistency> is verified by the communication contents structure verification 323, a communication service execution request 326 is made. This execution request corresponds to event driving 327 as a service execution process of the user party, and communication service execution 328 is made in response to this execution request 326. This service execution is supported by a service system 329.

Also for an object network responsible for a service capability in a certain node within the network, it is necessary to secure the security of its service execution process, a communication for using a service by performing the process for a consistent restriction item within the attribute structures of noun and verb objects of the object network.

A consistent restriction item has the following characteristics when a service is executed in a network. The first characteristic is that execution efficiency is improved by controlling a service execution process with a temporal item of a consistent restriction added to a verb object.

The second characteristic is that a formal object item and a characteristic object item, which are possessed by a noun object, can be individually checked by using the consistent restriction of the noun object, as the checking of appropriateness of the security required for service execution.

The third characteristic is that the appropriateness of a service execution operation can be checked with the consistent restriction item of the verb object.

The fourth characteristic is that the consistent restriction item must be encrypted to prevent the stealing of consistent restriction item data, or the abuse of data, such as tampering of data by a hacker.

The fifth characteristic is that consistent restriction item data can possibly be used without permission by a dealer who illegally accumulates and search for such data, or a network administrator.

The sixth characteristic is that there is a large necessity to hierarchically add the concept of a service in a network also to a consistent restriction item itself. Therefore, it is important to put the concept of a service into hardware, a chip, or firmware.

In a service operation using a network structure, an interaction capability between a network administration system of a certain service and a client is a fundamental frame. If the client makes a connection to the administration system with the interaction capability, data for the connection is exchanged. The data is sometimes used as an ID of the client. Accordingly, there is a high possibility that the ID is used as a means, and various types of data existing within the client system are absorbed by the administration system.

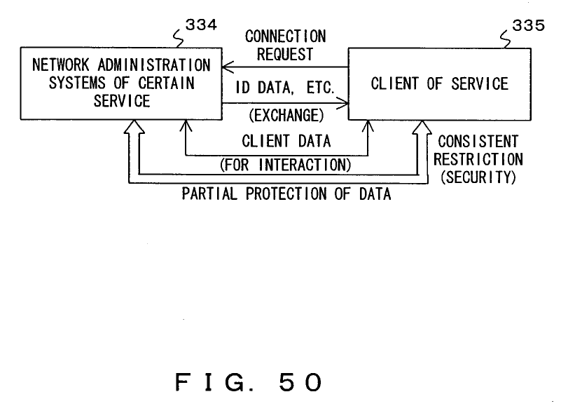

FIG. 50 explains a method for protecting data in a service interaction so as to cope with such a possibility. In this figure, in response to a connection request from a client 335 of a certain service to a network administration system 334 of the certain service, ID data, etc. are exchanged between the system and the client. Then, an interaction is made using the data of the client. In this interaction, partial protection of the data is made to maintain the security by using a consistent restriction.

Namely, data protection is made in such a way that data is prevented from being absorbed, and partial blocking of an interaction capability can be also made by making appropriateness checking using a gate action and encryption for a communication in a consistent restriction item of a WELL system for data accessed by an interaction with the use of a security securing capability used for each model in a hierarchical object structure composed of a data model, an object model, a role model, and a process model.

As described above, client privacy must be protected with the top priority, if an interaction for providing a service is made by using a network structure. A network administration system which provides a service must have a structure required for protecting the privacy of a client associated with a service providing operation.

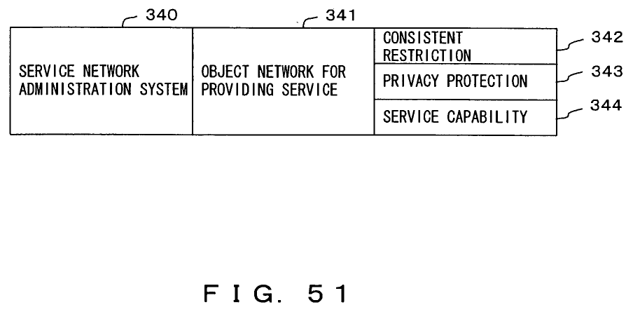

FIG. 51 shows the structure of such a service network administration system. A service network administration system 340 comprises an object network 341 for providing a service. The service network administration system 340 is structured to comprise a consistent restriction 342, privacy protection 343, and a service capability 344 in correspondence with the object network 341.

In the network service system, a service capability is made complex as described above, and the service capability in each node changes according to the mutual relationship among nodes. Such a change in the service capability is made with a change in an attribute of a party corresponding to a node. Therefore, the data protection described with reference to FIG. 50 must be made individually for a corresponding consistent restriction item. Also structuring of consistent restrictions of the service network administration system shown in FIG. 51 must be adaptively made.

Especially for a consistent restriction item, privacy protection must be dynamically made so as not to be noticed by a party on the other side. More generally, an adaptation operation for a goal must be dynamically performed according to the status of a service capability within a network.

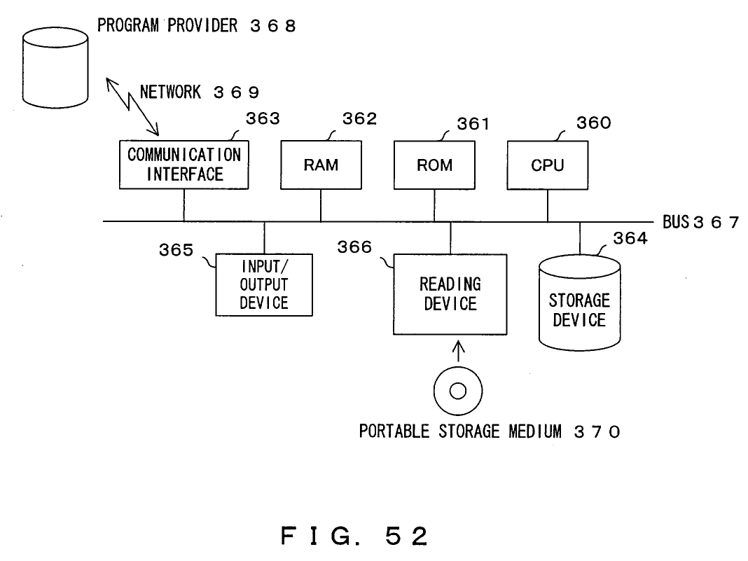

Up to this point, the network service system according to the present invention is described in detail. An intention realization data processing device, etc. which configure this system, can be configured as a general computer system as a matter of course. FIG. 52 is a block diagram showing such a computer system, namely, the configuration of hardware environment as an example.

In FIG. 52, the computer system is configured by a central processing unit (CPU) 360, a read-only memory (ROM) 361, a random access memory (RAM) 362, a communication interface 363, a storage device 364, an input/output device 365, a portable storage medium reading device 366, and a bus 367 to which the above described constituent elements are connected.

As the storage device 364, various forms of storage devices such as a hard disk, a magnetic disk, etc. are available. The programs represented by the flowcharts of FIGS. 9, 10, 19, etc., a program for implementing the intention of each party of the system, and the like are stored in such a storage device 364 or ROM 361. These programs are executed by the CPU 360, whereby the network service system according to the present invention can be implemented.

These programs may be stored, for example, in the storage device 364 via a network 369 and the communication interface 363 from a program provider 368 side, or may be stored on a marketed and distributed portable storage medium 370, set in the reading device 366, and executed by the CPU 360. As the portable storage medium 370, various forms of storage media such as a CD-ROM, a flexible disk, an optical disk, a magneto-optical disk, etc. are available. The programs stored on such a storage medium are read by the reading device 366, so that various types of processes for realizing the intention of a client or a server in the present invention can be performed.

As described above in detail, according to the present invention, in a network service system where, for example, a client as a user receives a service, the fundamental capability of an interaction between a party and the system is configured by an intention realization data processing system including a WELL system, common data for providing/receiving a service is centrally managed as overall external environment data, and an associated party is allowed to reference the data in a parallel manner at an arbitrary time point, whereby the network service system which efficiently and safely provides the service in a network can be implemented.

What is claimed is:

1. A network service system where a service is provided/received among a plurality of parties via a network, comprising:
an intention realization data processing device, which is an object-oriented data processing device for realizing an intention to provide/receive the service by each of the plurality of parties, comprising a common platform as an interface capability with each of the plurality of parties, and an object network for realizing the intention of each of the plurality of parties; and
an overall external environment data managing unit centrally managing common data that can be referenced by each of the plurality of parties in a parallel manner via the intention realization data processing device when requiring the data, and is intended to provide/receive the service.

2. The network service system according to claim 1, wherein
each of the plurality of parties comprises the intention realization data processing device, and makes an interaction with a different party via the network.

3. The network service system according to claim 1, further comprising
an intention target field defining unit defining a service target field as a target field of an intention, wherein
said overall external environment data managing unit centrally manages data of the service target field.

4. The network service system according to claim 1, wherein
the intention realization data processing device further comprises a consistency determining unit determining a consistent restriction condition corresponding to a goal of a service provided/received among the plurality of parties.

5. The network service system according to claim 4, wherein:
an object-oriented object has a hierarchical structure, which is configured by a data model whose attribute structure is decided as a template, an object model which is positioned higher than the data model, and comprises the object network having a graph structure where a name of a noun object is a node, and a name of a verb object is a branch, a role model which is positioned higher than the object model, and represents contents of a process to be executed in an environment as an assembly of object models, and a process model which is positioned highest, and defines a dynamic process that is cooperatively executed by a plurality of role models as one process; and
said consistency determining unit performs a control for implementing a service intended by a party according to a determination of a consistent restriction item added to the template.

6. The network service system according to claim 4, wherein
said consistency determining unit protects privacy in a communication by checking a consistent restriction condition regarding the communication made by the intention realization data processing device.

7. The network service system according to claim 1, wherein
said overall external environment data managing unit accumulates, as a characteristic parameter for each of the plurality of. parties, a result of an intention operation performed based on external environment data in correspondence with intentions of the plurality of parties via the intention realization data processing device.

8. The network service system according to claim 7, wherein
the intention realization data processing device further comprises an intention execution supporting unit extracting the characteristic parameter accumulated in said overall external environment data managing unit so as to evaluate and adapt the intention operation performed in correspondence with the intentions of the plurality of parties.

9. The network service system according to claim 8, wherein:
the plurality of parties correspond to respective parties of a team configured by a manager and team members; and
the respective parties realize an intention as a team by extracting the characteristic parameter accumulated in said overall external environment data managing unit with the use of said intention execution supporting unit.

10. The network service system according to claim 9, wherein
the intention realization data processing device each comprises a system adapting unit making system adaptation for realizing the intention of each of the plurality of parties in correspondence with a service category as a service menu, which respectively corresponds to one or more parties associated with the manager side.
